(19) United States
(12) Patent Application Publication
(10) Pub. No.: US 2026/0046773 A1
(43) Pub. Date: Feb. 12, 2026

(54) SYSTEMS, METHODS, AND DEVICES FOR SUPPORTING UE WAKE-UP DELAY CAPABILITIES

(71) Applicant: Apple Inc., Cupertino, CA (US)

(72) Inventors: Sigen YE, San Diego, CA (US); Seyed Ali Akbar FAKOORIAN, San Diego, CA (US); Wei ZENG, Saratoga, CA (US); Huaning NIU, San Jose, CA (US); Dawei ZHANG, Saratoga, CA (US); Seung Hee HAN, San Jose, CA (US)

(21) Appl. No.: 19/279,764

(22) Filed: Jul. 24, 2025

Related U.S. Application Data
(60) Provisional application No. 63/680,533, filed on Aug. 7, 2024.

(51) Int. Cl. H04W 52/02

(52) U.S. Cl. CPC H04W 52/0235; H04W 52/0219

(57) ABSTRACT

The techniques described herein can include solutions for supporting user equipment (UE) wake-up delay capabilities. One or more UEs can communicate, to a base station, wake-up delay capability information indicating one or more wake-up delays supported by each UE. The base station can determine, based on the wake-up delay capability information, UE groups and a low-power wake-up signal (LP-WUS) configuration for each UE group. The base station can transmit the LP-WUS configuration for each UE group to the one or more UEs of each UE group. In some examples, LP-WUS configurations include LP-WUS occasions that are separated from paging occasions by time gaps. The UE can identify at least one time gap of the LP-WUS configuration information that is greater than or equal to at least one wake-up delay supported by the UE and monitor a LP-WUS configuration associated with the time gap.

### CROSS REFERENCE TO RELATED APPLICATIONS

This application claims the benefit of U.S. Provisional Application No. 63/680,533, filed Aug. 7, 2024, the content of which is herein incorporated by reference in its entirety for all purposes.

### FIELD

This disclosure relates to wireless communication networks and mobile device capabilities.

### BACKGROUND

Wireless communication networks and wireless communication services are becoming increasingly dynamic, complex, and ubiquitous. For example, some wireless communication networks can be developed to implement fourth generation (4G), fifth generation (5G) or new radio (NR) technology. Such technology can include solutions for enabling user equipment (UE) and network devices, such as base stations, to communicate with one another. An aspect of such technology can include enabling mobile devices to enter and exit different power saving modes.

### BRIEF DESCRIPTION OF THE DRAWINGS

The present disclosure will be readily understood and enabled by the detailed description and accompanying figures of the drawings. Like reference numerals can designate like features and structural elements. Figures and corresponding descriptions are provided as non-limiting examples of aspects, implementations, etc., of the present disclosure, and references to “an” or “one” aspect, implementation, etc., may not necessarily refer to the same aspect, implementation, etc., and can mean at least one, one or more, etc.

FIG. 1 is a diagram of an example of an overview according to one or more implementations described herein.

FIG. 2 is a diagram of an example network according to one or more implementations described herein.

FIG. 3 is a diagram of an example process for supporting user equipment (UE) wake-up capabilities according to one or more implementations described herein.

FIG. 4 is a diagram of an example of supporting UE wake-up capabilities according to one or more implementations described herein.

FIG. 5 is a diagram of an example of supporting UE wake-up capabilities according to one or more implementations described herein.

FIG. 6 is a diagram of an example of supporting UE wake-up capabilities according to one or more implementations described herein.

FIG. 7 is a diagram of an example of supporting UE wake-up capabilities according to one or more implementations described herein.

FIG. 8 is a diagram of an example of supporting UE wake-up capabilities according to one or more implementations described herein.

FIG. 9 is a diagram of an example of components of a device according to one or more implementations described herein.

FIG. 10 is a diagram of example interfaces of baseband circuitry according to one or more implementations described herein.

FIG. 11 is a block diagram illustrating components, according to one or more implementations described herein, able to read instructions from a machine-readable or computer-readable medium (e.g., a non-transitory machine-readable storage medium) and perform any one or more of the methodologies discussed herein.

FIG. 12 is a diagram of an example process for supporting UE wake-up delay capabilities according to one or more implementations described herein.

FIG. 13 is a diagram of an example process for supporting UE wake-up delay capabilities according to one or more implementations described herein.

FIG. 14 is a diagram of an example process for supporting UE wake-up delay capabilities according to one or more implementations described herein.

### DETAILED DESCRIPTION

The following detailed description refers to the accompanying drawings. Like reference numbers in different drawings can identify the same or similar features, elements, operations, etc. Additionally, the present disclosure is not limited to the following description as other implementations can be utilized, and structural or logical changes made, without departing from the scope of the present disclosure.

Telecommunication networks can include user equipment (UEs) capable of communicating with base stations and/or other network access nodes. UEs and base stations can implement various techniques and communications standards for enabling UEs and base stations to discover one another, establish and maintain connectivity, and exchange information in an ongoing manner. Objectives of such techniques can include enabling UEs to reliably and efficiently transition between different states or modes of operation involving different rates of power consumption.

In legacy operations, a UE in an idle or inactive state can wake up once according to a discontinuous reception mode (DRX) cycle to monitor paging occasions (POs) of a physical downlink control channel (PDCCH). The UE can wake up as needed to perform radio resource management (RRM) measurements. The UE can stay in a deep sleep state in between measurements to save power.

A base station can transmit a low-power wake-up signal (LP-WUS) to the UE while the UE is in an idle state. The UE can monitor for a LP-WUS for a defined duration, or a LP-WUS occasion (LO), using a low-power wake-up receiver (LP-WUR). The LP-WUS can indicate to the UE whether there is an upcoming communication, such as a paging message, thereby enabling the UE to remain in an idle state or transition to an active state depending on the LP-WUS. The LP-WUR is expected to consume much less power than the main radio (MR) of the UE, which is used e.g. for PO monitoring. While the UE monitors LP-WUS, the MR can stay in a very deep sleep state. Only when the UE receives the LP-WUS and the LP-WUS indicates an upcoming communication, the UE can wake up the MR to monitor for, receive, and decode the communication. For example, the UE can monitor a paging occasion (PO) for a paging message as indicated by the LP-WUS. Thus, the UE can wake up when a paging message is scheduled.

However, it can take a relatively long time to wake up the MR if the MR is in a very deep sleep state. The UE may not be able to receive the paging message if the wake-up delay (e.g., a period of time between the LP-WUS and the paging message or PO) is not sufficiently large. Different UEs can have different configurations relating to the wake-up delay time. For example, UEs with less strict latency requirements can have a longer wake-up delay to allow the UE to enter a deeper sleep state. UEs with stricter latency requirements, such as smartphones, can have a smaller wake-up delay. Further, different UEs can have different wake-up delay capabilities or vary in the time involved in transition out of the sleep state after receiving a wake-up signal. Currently available technologies provide no or inadequate solutions for addressing varying wake-up delay capabilities of different UEs.

One or more of the techniques described herein provide solutions for supporting UEs with different wake-up delay capabilities. One or more UEs can report wake-up delay capabilities to the base station. The base station can transmit LP-WUSs based on the reports. For example, groups of UEs can have similar wake-up delay capabilities, enabling the base station to schedule multiple UEs with the same wake-up delay. In some examples, the base station can configure the LP-WUS occasions with a single wake-up delay for a group of UEs, or a subgroup of UEs. In some examples, the base station can configure different wake-up delays for different groups and/or subgroups of UEs. In some examples, a base station can configure a single UE with a wake-up delay, configuring the UE to wake in response to a LP-WUS and monitor for a first paging occasion after the wake-up delay.

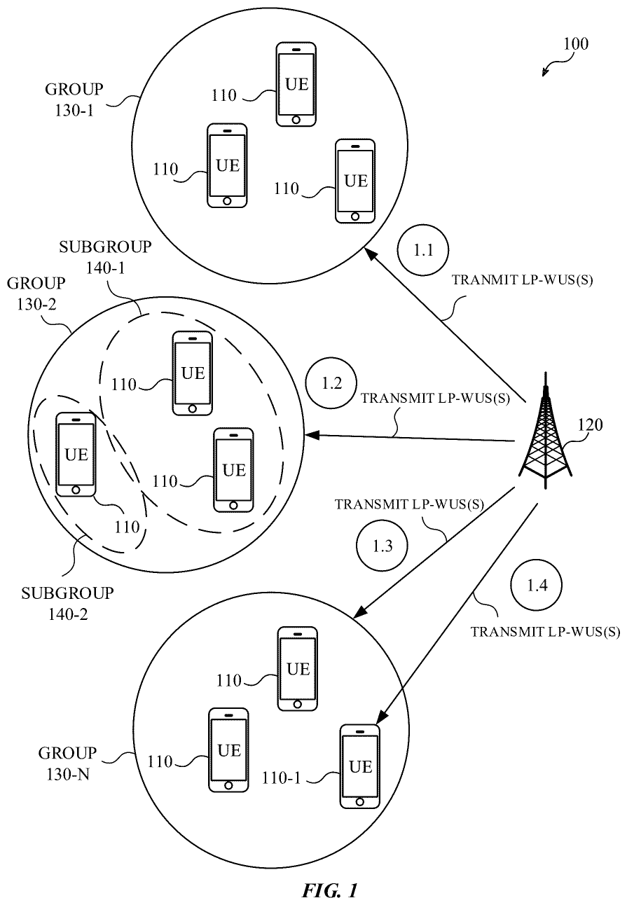

FIG. 1 is a diagram of an example of an overview 100 according to one or more implementations described herein. As shown, overview 100 can include UEs 110, UE groups 130, and base station 120. Base station 120 can communicate with one or more UE groups 130, UE subgroups 140, and individual UEs 110. UE groups 130 can include multiple UEs 110 and/or UE subgroups 140 of UEs 110. While shown with three UEs 110, there can be any number of UEs 110 in a UE group or UE subgroup.

Base station 120 can support different UE wake-up delay capabilities. Base station 120 can receive UE wake-up delay capability reports or information from one or more UEs 110. Base station 120 can group UEs 110 into UE groups 130 (e.g., group 130-1, group 130-2, . . . , group 130-N) and/or subgroups 140 (e.g., subgroup 140-1, subgroup 140-2) based on the wake-up delay capabilities of UEs 110. For example, base station 120 can group (e.g., sort, divide, arrange, organize, etc.) UEs 110 with similar wake-up delay capabilities.

Base station 120 can send LP-WUS configurations to groups 130, subgroups 140, individual UEs 110, or a combination thereof. LP-WUS configurations can include LP-WUS occasion scheduling, paging occasion scheduling, and time gaps between LP-WUS occasions and paging occasions. For example, a LP-WUS configuration can prompt or cause UE 110 to monitor a LP-WUS occasion and a paging occasion that are mapped, or otherwise logically associated with, one another according to the LP-WUS configuration information. In some examples, base station 120 can indicate the same LP-WUS configurations to groups 130 or subgroups 140.

In some examples, base station 120 can use the LP-WUS configurations to map multiple LP-WUS occasions to a single time gap and the same paging occasion for group 130 or subgroup 140. In such scenarios, base station 120 can transmit LP-WUSs during one LP-WUS occasion to each UE 110 of group 130-1 (at 1.1). Upon expiration of the time gap, UEs 110 of group 130-1 can monitor the same paging occasion for a paging message. In some examples, a time gap can start at the beginning of a LP-WUS occasion, the end of the LP-WUS occasion, or the start or the end of the frame containing the LP-WUS occasion. A time gap can end at the start of the paging occasion or the start of the paging frame that contains the paging occasion.

In some examples, base station 120 can configure different groups 130 or subgroups 140 to monitor candidate LP-WUS occasions that are associated with different time gaps but the same paging occasion. For example, base station 120 can configure a first LP-WUS occasion for subgroup 140-1 and a second LP-WUS occasion for subgroup 140-2, where both LP-WUSs have the same paging occasion but different time gaps. Base station 120 can transmit LP-WUSs at different times and with different times gaps to subgroup 140-1 and subgroup 140-2 (at 1.2). Subgroup 140-1 and subgroup 140-2 can monitor for the same paging occasion after receiving LP-WUSs at different times. In some examples, UEs 110 of subgroup 140 can select which LP-WUS occasion to monitor prior to the paging occasion based on wake-up delay capabilities. For example, a UE 110 with a shorter wake-up delay capability can monitor a LP-WUS occasion with a smaller time gap.

In some implementations, base station 120 can configure multiple candidate LP-WUS occasions with multiple time gaps for the same paging occasion for multiple groups. For example, base station 120 can configure a first LP-WUS occasion for group 130-1, a second LP-WUS occasion for group 130-2, and an n LP-WUS occasion for group 130-N. All LP-WUSs can be configured with the same paging occasion, such that, each group 130 can observe different time gaps. Base station 120 can transmit LP-WUSs at different times and with different times gaps to each group 130, such as group 130-N (at 1.3). In some examples, each group 130 can monitor for the same paging occasion despite receiving LP-WUSs at different times. In some implementations, base station 120 can configure different LP-WUS occasions and different paging occasions with different time groups for different groups 130 or subgroups 140.

In some scenarios, base station 120 can configure LP-WUS occasions to be monitored by a single UE 110, such as UE 110-1 (at 1.4). When UE 110-1 receives the LP-WUS, UE 110-1 can monitor a first paging occasion that is after the wake-up delay of UE 110-1. The wake-up delay can begin or be measured from the LP-WUS occasions or LP-WUS. Additionally, the LP-WUS or LP-WUS configuration may not map the LP-WUS to the first paging occasion. Instead, the paging occasion intended for UE 110-1 can be inferred by UE 110 and/or base station 120 based on a combination of the LP-WUS and the wake-up delay of UE 110-1.

Accordingly, one or more of the techniques described herein may provide solutions for supporting UE wake-up delay capabilities. These and many other features and aspects of the techniques described herein are presented below with reference to remaining Figures.

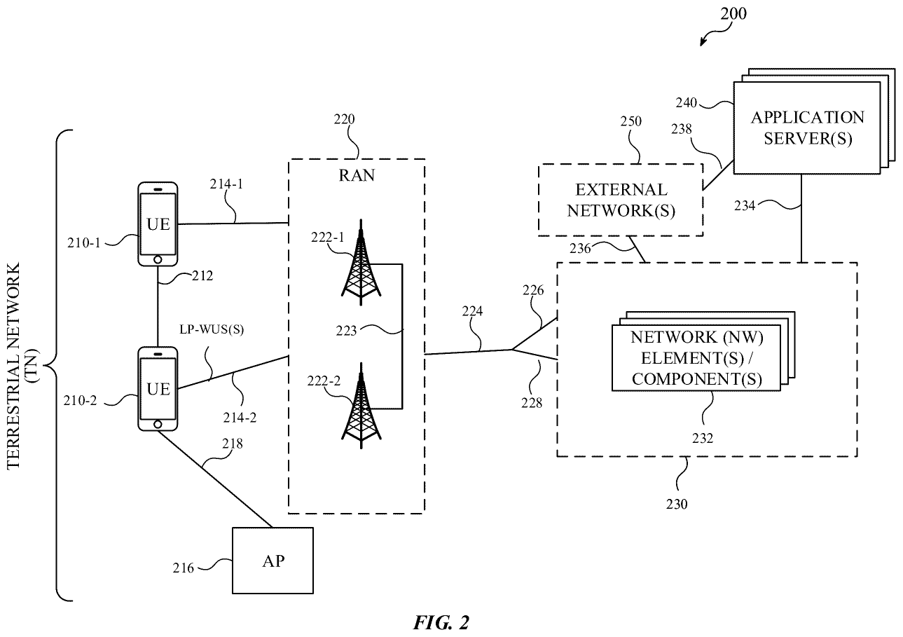

FIG. 2 is an example network 200 according to one or more implementations described herein. Example network 200 can include UEs 210, 210-2, etc. (referred to collectively as “UEs 210” and individually as “UE 210”), a radio access network (RAN) 220, a core network (CN) 230, application servers 240, and external networks 250.

The systems and devices of example network 200 can operate in accordance with one or more communication standards, such as 2nd generation (2G), 3rd generation (3G), 4th generation (4G) (e.g., long-term evolution (LTE)), and/or 5th generation (5G) (e.g., new radio (NR)) communication standards of the 3rd generation partnership project (3GPP). Additionally, or alternatively, one or more of the systems and devices of example network 200 can operate in accordance with other communication standards and protocols discussed herein, including future versions or generations of 3GPP standards (e.g., sixth generation (6G) standards, seventh generation (7G) standards, etc.), institute of electrical and electronics engineers (IEEE) standards (e.g., wireless metropolitan area network (WMAN), worldwide interoperability for microwave access (WiMAX), etc.), and more.

As shown, UEs 210 can include smartphones (e.g., handheld touchscreen mobile computing devices connectable to one or more wireless communication networks). Additionally, or alternatively, UEs 210 can include other types of mobile or non-mobile computing devices capable of wireless communications, such as personal data assistants (PDAs), pagers, laptop computers, desktop computers, wireless handsets, etc. In some implementations, UEs 210 can include internet of things (IoT) devices (or IoT UEs) that can comprise a network access layer designed for low-power IoT applications utilizing short-lived UE connections. Additionally, or alternatively, an IoT UE can utilize one or more types of technologies, such as machine-to-machine (M2M) communications or machine-type communications (MTC) (e.g., to exchanging data with an MTC server or other device via a public land mobile network (PLMN)), proximity-based service (ProSc) or device-to-device (D2D) communications, sensor networks, IoT networks, and more. Depending on the scenario, an M2M or MTC exchange of data can be a machine-initiated exchange, and an IoT network can include interconnecting IoT UEs (which can include uniquely identifiable embedded computing devices within an Internet infrastructure) with short-lived connections. In some scenarios, IoT UEs can execute background applications (e.g., keep-alive messages, status updates, etc.) to facilitate the connections of the IoT network.

UEs 210 can communicate and establish a connection with one or more other UEs 210 via one or more wireless channels 212, each of which can comprise a physical communications interface/layer. The connection can include an M2M connection, MTC connection, D2D connection, SL connection, etc. The connection can involve a PC5 interface. In some implementations, UEs 210 can be configured to discover one another, negotiate wireless resources between one another, and establish connections between one another, without intervention or communications involving RAN node 222 or another type of network node. In some implementations, discovery, authentication, resource negotiation, registration, etc., can involve communications with RAN node 222 or another type of network node.

UEs 210 can use one or more wireless channels 212 to communicate with one another. As described herein, UE 210 can communicate with RAN node 222 to request SL resources. RAN node 222 can respond to the request by providing UE 210 with a dynamic grant (DG) or configured grant (CG) regarding SL resources. A DG can involve a grant based on a grant request from UE 210. A CG can involve a resource grant without a grant request and can be based on a type of service being provided (e.g., services that have strict timing or latency requirements). UE 210 can perform a clear channel assessment (CCA) procedure based on the DG or CG, select SL resources based on the CCA procedure and the DG or CG; and communicate with another UE 210 based on the SL resources. The UE 210 can communicate with RAN node 222 using a licensed frequency band and communicate with the other UE 210 using an unlicensed frequency band.

UEs 210 can communicate and establish a connection with (e.g., be communicatively coupled) with RAN 220, which can involve one or more wireless channels 214-1 and 214-2, each of which can comprise a physical communications interface/layer. In some examples, UE 210 can receive LP-WUSs from RAN node 222 via the wireless channels 214. In some implementations, a UE can be configured with dual connectivity (DC) as a multi-radio access technology (multi-RAT) or multi-radio dual connectivity (MR-DC), where a multiple receive and transmit (Rx/Tx) capable UE can use resources provided by different RAN network nodes (e.g., RAN network nodes 222-1 and 222-2) that can be connected via non-ideal backhaul (e.g., where one network node provides NR access and the other network node provides either E-UTRA for LTE or NR access for 5G). In such a scenario, one network node can operate as a master node (MN) and the other as the secondary node (SN). The MN and SN can be connected via a network interface, and at least the MN can be connected to the CN 230. Additionally, at least one of the MN or the SN can be operated with shared spectrum channel access, and functions specified for UE 210 can be used for an integrated access and backhaul mobile termination (IAB-MT). Similar for UE 210, the IAB-MT can access the network using either one network node or using two different nodes with enhanced dual connectivity (EN-DC) architectures, new radio dual connectivity (NR-DC) architectures, or the like. In some implementations, a base station (as described herein) can be an example of network RAN network nodes.

As shown, UE 210 can also, or alternatively, connect to access point (AP) 216 via connection interface 218, which can include an air interface enabling UE 210 to communicatively couple with AP 216. AP 216 can comprise a wireless local area network (WLAN), WLAN node, WLAN termination point, etc. The connection 218 can comprise a local wireless connection, such as a connection consistent with any IEEE 702.11 protocol, and AP 216 can comprise a wireless fidelity (Wi-Fi®) router or other AP. While not explicitly depicted in FIG. 2, AP 216 can be connected to another network (e.g., the Internet) without connecting to RAN 220 or CN 230. In some scenarios, UE 210, RAN 220, and AP 216 can be configured to utilize LTE-WLAN aggregation (LWA) techniques or LTE WLAN radio level integration with IPsec tunnel (LWIP) techniques. LWA can involve UE 210 in RRC_CONNECTED being configured by RAN 220 to utilize radio resources of LTE and WLAN. LWIP can involve UE 210 using WLAN radio resources (e.g., connection interface 218) via IPsec protocol tunneling to authenticate and encrypt packets (e.g., Internet Protocol (IP) packets) communicated via connection interface 218. IPsec tunneling can include encapsulating the entirety of original IP packets and adding a new packet header, thereby protecting the original header of the IP packets.

RAN 220 can include one or more RAN nodes 222-1 and 222-2 (referred to collectively as RAN nodes 222, and individually as RAN node 222) that enable channels 214-1 and 214-2 to be established between UEs 210 and RAN 220. RAN nodes 222 can include network access points configured to provide radio baseband functions for data and/or voice connectivity between users and the network based on one or more of the communication technologies described herein (e.g., 2G, 3G, 4G, 5G, WiFi®, etc.). As examples therefore, a RAN node can be an E-UTRAN Node B (e.g., an enhanced Node B, eNodeB, eNB, 4G base station, etc.), a next generation base station (e.g., a 5G base station, NR base station, next generation eNBs (gNB), etc.). RAN nodes 222 can include a roadside unit (RSU), a transmission reception point (TRxP or TRP), and one or more other types of ground stations (e.g., terrestrial access points). In some scenarios, RAN node 222 can be a dedicated physical device, such as a macrocell base station, and/or a low power (LP) base station for providing femtocells, picocells or the like having smaller coverage areas, smaller user capacity, or higher bandwidth compared to macrocells.

Some or all of RAN nodes 222, or portions thereof, can be implemented as one or more software entities running on server computers as part of a virtual network, which can be referred to as a centralized RAN (CRAN) and/or a virtual baseband unit pool (vBBUP). In these implementations, the CRAN or vBBUP can implement a RAN function split, such as a packet data convergence protocol (PDCP) split wherein radio resource control (RRC) and PDCP layers can be operated by the CRAN/vBBUP and other Layer 2 (L2) protocol entities can be operated by individual RAN nodes 222; a media access control (MAC)/physical (PHY) layer split wherein RRC, PDCP, radio link control (RLC), and MAC layers can be operated by the CRAN/vBBUP and the PHY layer can be operated by individual RAN nodes 222; or a “lower PHY” split wherein RRC, PDCP, RLC, MAC layers and upper portions of the PHY layer can be operated by the CRAN/vBBUP and lower portions of the PHY layer can be operated by individual RAN nodes 222. This virtualized framework can allow freed-up processor cores of RAN nodes 222 to perform or execute other virtualized applications.

In some implementations, an individual RAN node 222 can represent individual gNB-distributed units (DUs) connected to a gNB-control unit (CU) via individual F1 or other interfaces. In such implementations, the gNB-DUs can include one or more remote radio heads or radio frequency (RF) front end modules (RFEMs), and the gNB-CU can be operated by a server (not shown) located in RAN 220 or by a server pool (e.g., a group of servers configured to share resources) in a similar manner as the CRAN/vBBUP. Additionally, or alternatively, one or more of RAN nodes 222 can be next generation eNBs (i.e., gNBs) that can provide evolved universal terrestrial radio access (E-UTRA) user plane and control plane protocol terminations toward UEs 210, and that can be connected to a 5G core network (5GC) 230 via an NG interface.

Any of the RAN nodes 222 can terminate an air interface protocol and can be the first point of contact for UEs 210. In some implementations, any of the RAN nodes 222 can fulfill various logical functions for the RAN 220 including, but not limited to, radio network controller (RNC) functions such as radio bearer management, uplink and downlink dynamic radio resource management and data packet scheduling, and mobility management. UEs 210 can be configured to communicate using orthogonal frequency-division multiplexing (OFDM) communication signals with each other or with any of the RAN nodes 222 over a multicarrier communication channel in accordance with various communication techniques, such as, but not limited to, an OFDMA communication technique (e.g., for downlink communications) or a single carrier frequency-division multiple access (SC-FDMA) communication technique (e.g., for uplink and ProSc or sidelink (SL) communications), although the scope of such implementations may not be limited in this regard. The OFDM signals can comprise a plurality of orthogonal subcarriers.

In some implementations, a downlink resource grid can be used for downlink transmissions from any of the RAN nodes 222 to UEs 210, and uplink transmissions can utilize similar techniques. The grid can be a time-frequency grid (e.g., a resource grid or time-frequency resource grid) that represents the physical resource for downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises resource blocks, which describe the mapping of certain physical channels to resource elements. Each resource block can comprise a collection of resource elements (REs); in the frequency domain, this can represent the smallest quantity of resources that currently can be allocated. There are several different physical downlink channels that are conveyed using such resource blocks.

Further, RAN nodes 222 can be configured to wirelessly communicate with UEs 210, and/or one another, over a licensed medium (also referred to as the “licensed spectrum” and/or the “licensed band”), an unlicensed shared medium (also referred to as the “unlicensed spectrum” and/or the “unlicensed band”), or combination thereof. A licensed spectrum can correspond to channels or frequency bands selected, reserved, regulated, etc., for certain types of wireless activity (e.g., wireless telecommunication network activity), whereas an unlicensed spectrum can correspond to one or more frequency bands that are not restricted for certain types of wireless activity. Whether a particular frequency band corresponds to a licensed medium or an unlicensed medium can depend on one or more factors, such as frequency allocations determined by a public-sector organization (e.g., a government agency, regulatory body, etc.) or frequency allocations determined by a private-sector organization involved in developing wireless communication standards and protocols, etc.

To operate in the unlicensed spectrum, UEs 210 and the RAN nodes 222 can operate using stand-alone unlicensed operation, licensed assisted access (LAA), eLAA, and/or feLAA mechanisms. In these implementations, UEs 210 and the RAN nodes 222 can perform one or more known medium-sensing operations or carrier-sensing operations in order to determine whether one or more channels in the unlicensed spectrum is unavailable or otherwise occupied prior to transmitting in the unlicensed spectrum. The medium/carrier sensing operations can be performed according to a listen-before-talk (LBT) protocol.

The PDSCH can carry user data and higher layer signaling to UEs 210. The physical downlink control channel (PDCCH) can carry information about the transport format and resource allocations related to the PDSCH channel, among other things. The PDCCH can also inform UEs 210 about the transport format, resource allocation, and hybrid automatic repeat request (HARQ) information related to the uplink shared channel. Typically, downlink scheduling (e.g., assigning control and shared channel resource blocks to UE 210 within a cell) can be performed at any of the RAN nodes 222 based on channel quality information fed back from any of UEs 210. The downlink resource assignment information can be sent on the PDCCH used for (e.g., assigned to) each of UEs 210.

One or more of the techniques, described herein, can enable support of varying UE 210 wake-up delay capabilities. For example, UE 210 can report a wake-up delay capability report indicating one or more values of supported wake-up delay times to the network, such as RAN nodes 222 or base station 222. In some examples, base station 222 can assign UE 210 a group or subgroup of UEs, or the UE can determine its group or subgroup based on some predefined rules or formula. Base station 222 can indicate a LP-WUS configuration to UE 210 based on wake-up delay capabilities UE 210 and, if applicable, the group or subgroup assignment. The LP-WUS configuration can include LP-WUS occasion scheduling, time gaps between LP-WUS occasions and paging occasions, and paging occasion scheduling. UE 210 can monitor for LP-WUS occasions according to the LP-WUS configuration. In some examples, UE 210 can receive a LP-WUS indicating wake-up and, according to the LP-WUS configuration, monitor a paging occasion after a time gap.

The RAN nodes 222 can be configured to communicate with one another via interface 223. In implementations where the system is an LTE system, interface 223 can be an X2 interface. In NR systems, interface 223 can be an Xn interface. The X2 interface can be defined between two or more RAN nodes 222 (e.g., two or more eNBs/gNBs or a combination thereof) that connect to evolved packet core (EPC) or CN 230, or between two eNBs connecting to an EPC. The RAN nodes 222 can be configured to communicate with the CN 230 via various interfaces, such as physical interfaces, including interface 224, interface 226, and interface 228.

In some implementations, the X2 interface can include an X2 user plane interface (X2-U) and an X2 control plane interface (X2-C). The X2-U can provide flow control mechanisms for user data packets transferred over the X2 interface and can be used to communicate information about the delivery of user data between eNBs or gNBs. For example, the X2-U can provide specific sequence number information for user data transferred from a master eNB (MeNB) to a secondary eNB (SeNB); information about successful in sequence delivery of PDCP packet data units (PDUs) to a UE 210 from an SeNB for user data; information of PDCP PDUs that were not delivered to a UE 210; information about a current minimum desired buffer size at the SeNB for transmitting to the UE user data; and the like. The X2-C can provide intra-LTE access mobility functionality (e.g., including context transfers from source to target eNBs, user plane transport control, etc.), load management functionality, and inter-cell interference coordination functionality.

As shown, RAN 220 can be connected (e.g., communicatively coupled) to CN 230. CN 230 can comprise a plurality of network elements 232, which are configured to offer various data and telecommunications services to customers/subscribers (e.g., users of UEs 210) who are connected to the CN 230 via the RAN 220. In some implementations, CN 230 can include an evolved packet core (EPC), a 5G CN, and/or one or more additional or alternative types of CNs. The components of the CN 230 can be implemented in one physical node or separate physical nodes including components to read and execute instructions from a machine-readable or computer-readable medium (e.g., a non-transitory machine-readable storage medium). In some implementations, network function virtualization (NFV) can be utilized to virtualize any or all the above-described network node roles or functions via executable instructions stored in one or more computer-readable storage mediums (described in further detail below). A logical instantiation of the CN 230 can be referred to as a network slice, and a logical instantiation of a portion of the CN 230 can be referred to as a network sub-slice. Network Function Virtualization (NFV) architectures and infrastructures can be used to virtualize one or more network functions, alternatively performed by proprietary hardware, onto physical resources comprising a combination of industry-standard server hardware, storage hardware, or switches. In other words, NFV systems can be used to execute virtual or reconfigurable implementations of one or more EPC components/functions.

As shown, CN 230, application servers 240, and external networks 250 can be connected to one another via interfaces 234, 236, and 238, which can include IP network interfaces. Application servers 240 can include one or more server devices or network elements (e.g., virtual network functions (VNFs) offering applications that use IP bearer resources with CN 230 (e.g., universal mobile telecommunications system packet services (UMTS PS) domain, LTE PS data services, etc.). Application servers 240 can also, or alternatively, be configured to support one or more communication services (e.g., voice over IP (VOIP) sessions, push-to-talk (PTT) sessions, group communication sessions, social networking services, etc.) for UEs 210 via the CN 230. Similarly, external networks 250 can include one or more of a variety of networks, including the Internet, thereby providing the mobile communication network and UEs 210 of the network access to a variety of additional services, information, interconnectivity, and other network features.

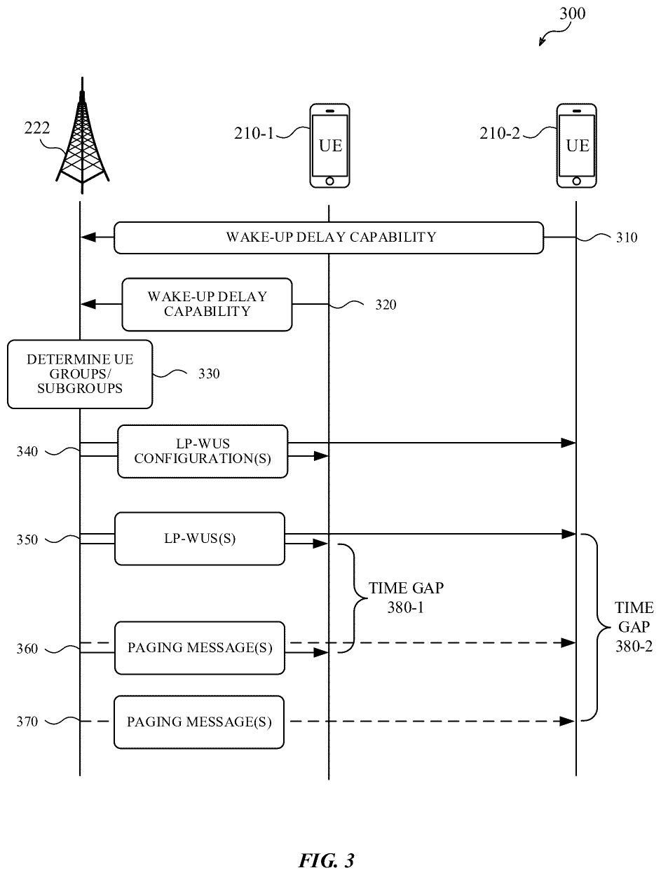

FIG. 3 is a diagram of an example process 300 for supporting UE wake-up delay capabilities according to one or more implementations described herein. Process 300 can be implemented by UE 210 and one or more base stations 222. In some implementations, some or all of process 300 can be performed by one or more other systems or devices, including one or more of the devices of FIG. 2. Additionally, process 300 can include one or more fewer, additional, differently ordered and/or arranged operations than those shown in FIG. 3. In some implementations, some or all of the operations of process 300 can be performed independently, successively, simultaneously, etc., of one or more of the other operations of process 300. As such, the techniques described herein are not limited to a number, sequence, arrangement, timing, etc., of the operations or processes depicted in FIG. 3.

Process 300 can include base station 222 communicating with multiple UEs 210, such as UE 210-1 and UE 210-2. Base station 222 can receive multiple wake-up delay capability reports from multiple UEs 210, where the wake-up delay capability reports can include one or more values of supported wake-up delays. A wake-up delay capability report can include one or more types of information indicating wake-up delay capabilities. Additionally, wake-up delay capability information, as referred to herein, can include one or more wake-up delay capability reports or other types of information indicating wake-up delay capabilities.

As shown, process 300 can include UE 210-1 transmitting, reporting, or otherwise communicating a wake-up delay capability of UE 210-1 (at 310). Additionally, process 300 can include UE 210-2 transmitting, reporting, or otherwise communicating a wake-up delay capability of UE 210-2 (at 320). The wake-up delay capabilities of UE 210-1 and UE 210-2 can be the same or different.

The wake-up delay capability report can indicate the capability of the UE 210 to support different values of wake-up delay (e.g., how much time is involved in UE 210 transitioning from a sleep state to an active state after receiving a wake-up indication). UE 210 can report a single value or can report multiple values of supported wake-up delay. The value can be a period of time, an identifier, or other type of reference associated with a period of time. In some examples, the wake-up delay can be defined as started from the beginning or the end of the LP-WUS occasion.

An idle state can be one of multiple sleep states of UE 210. Different values of wake-up delay can correspond to different sleep states with different rates of power consumption. A longer wake-up delay can be associated with a deeper sleep state with a lower rate of power consumption, whereas a shorter wake-up delay value can be associated with a shallower sleep state with a higher rate of power consumption. Different sleep states can vary based on UE 210 implementation, configuration, and capabilities.

In some examples, UEs 210 can report the wake-up delay capability to CN 230 (e.g., to an access and mobility management function (AMF) (not shown)). UEs 210 can report the wake-up delay capability to CN 230 during registration with CN 230, and CN 230 can store the wake-up delay capability (e.g., for UE 210). In some examples, the AMF can include the wake-up delay capability report from UEs 210 as part of a paging message to base station 222. Such messaging can enable base station 222 to transmit LP-WUSs and paging messages to UEs 210 according to the capabilities of UEs 210.

Process 300 can include base station 222 determining UE groups and/or UE subgroups (at 330). For example, base station 222 can assign each UE 110 to one or more groups, subgroups, or both. Base station 222 can determine UE groups/subgroups based on similarities of the wake-up delay capability reports and/or one or more other UE capabilities or configurations. For example, UEs 210 that report a same supported value of wake-up delay can be assigned to the same group or subgroup. In some examples, UE 210 can be assigned to its own group or be configured as a single UE 210.

Process 300 can include base station 222 communicating LP-WUS configurations to UE 210-1 and UE 210-2 (at 340). An LP-WUS configuration can include LP-WUS occasions and paging occasions for UE 210 to monitor, and time gaps between LP-WUS occasions and paging occasions. An LP-WUS configuration can include a mapping information or another type of logical association between one or more LP-WUS occasions, one or more paging occasions, and one or more time gaps. Base station 222 can configure UEs 210 based on the assigned group (or subgroup) of each UE 210 or configure UEs 210 individually.

Process 300 can include base station 222 transmitting LP-WUSs to UEs 210 (at 350). The LP-WUSs can correspond to the LP-WUS configurations. In some examples, base station 222 can transmit LP-WUSs at different times, or UE 210 can select a LP-WUS to monitor for and receive. LP-WUSs can cause or prompt UE 210 to wake up or otherwise transition to an active state.

Process 300 can include base station 222 transmitting paging messages to UE 210-1 and UE 210-2 (at 360). The paging messages can be sent during a paging occasion. In such examples, UE 210-1 and UE 210-2 can be configured to monitor the same paging occasion and can be assigned to the same group. In some examples, UE 210-1 and UE 210-2 can have similar wake-up delay capabilities. UE 210-1 and UE 210-2 can receive the paging messages after time gap 380-1.

In some examples, UE 210-1 and UE 210-2 can have different wake-up delay capabilities. Base station 222 can assign UE 210-1 and UE 210-2 to different groups, or subgroups, and configure UE 210-1 with time gap 380-1 and UE 210-2 with time gap 380-2. Base station 222 can transmit a message to UE 210-1 after time gap 380-1 (at 360) and transmit a message to UE 210-2 after time gap 380-2 (at 370). In such examples UE 210-1 and UE 210-2 can monitor for different paging occasions according to the different time gaps 380. In some examples, UE 210-1 and UE 210-2 can monitor for and receive different LP-WUS configurations with different time gaps 380 corresponding to the same paging occasion.

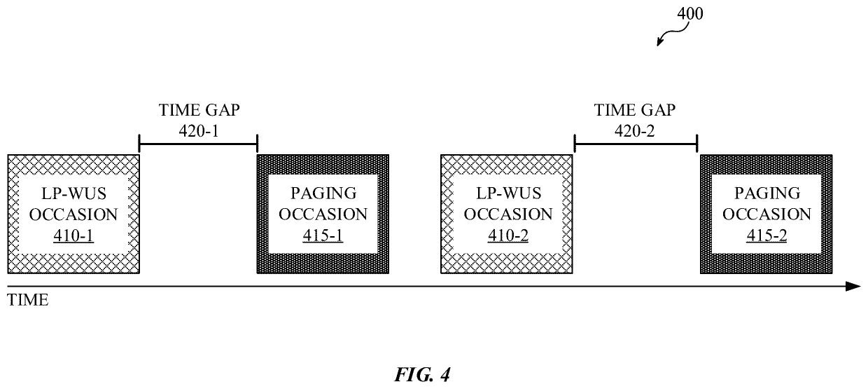

FIG. 4 is a diagram of an example 400 for supporting UE wake-up capabilities according to one or more implementations described herein. FIG. 4 depicts LP-WUS occasions 410 and paging occasions 415 scheduled for one or more UEs 210.

In some examples, different UEs 210, groups of UEs 210, and subgroups of UEs 210, can be configured with LP-WUS occasion 410-1, time gap 420-1, and paging occasion 415-1, or LP-WUS occasion 410-2, time gap 420-2, and paging occasion 415-2. A single time gap between the LP-WUS occasion and the corresponding PO can be applied to all the UEs. A group or subgroup of UEs 210 monitoring the same paging occasion 415 can be configured to monitor the same LP-WUS occasion 410. For example, a first group of UEs 110 monitoring LP-WUS occasion 410-1 can monitor paging occasion 415-1 after time gap 420-1, and a second group of UEs 110 monitoring LP-WUS occasion 410-2 can monitor paging occasion 415-2 after time gap 420-2. Time gap 420-1 and time gap 4202 can be the same for all the UEs. For example, time gaps 420 can be configured to be greater than or equal to one or more wake-up delays supported by UE 210.

Time gap 420 can be illustrated as beginning at the end of LP-WUS occasion 410 and ending at the start of paging occasion 415. In some examples, time gap 420 can start at the beginning of LP-WUS occasion 410, the end of LP-WUS occasion 410, or the start of the frame containing LP-WUS occasion 410. Time gap 420 can end at the start of paging occasion 415 or the start of the paging frame that contains paging occasion 415.

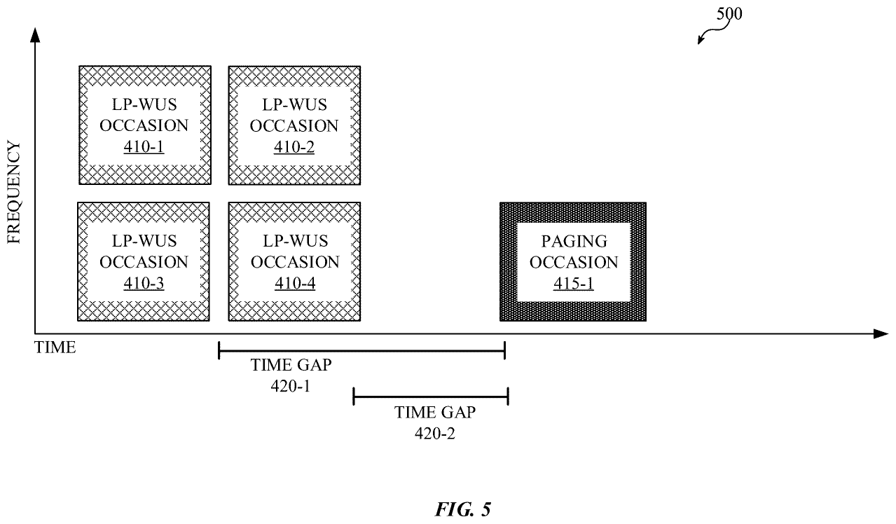

FIG. 5 is a diagram of an example 500 for supporting UE wake-up capabilities according to one or more implementations described herein. FIG. 5 describes multiple LP-WUS occasions 410 configured with the same paging occasion 415 and different time gaps 420. Different subgroups, or groups, or individual UEs 210 can monitor the same paging occasion 415. In some examples, multiple groups can be configured to monitor different LP-WUS occasion 410, or individual UEs 210 can be configured to monitor different LP-WUS occasions 410.

In some examples, a first subgroup can be configured to monitor LP-WUS occasion 410-1 and a second subgroup can be configured to monitor LP-WUS occasion 410-2 at the same frequency. A third subgroup can be configured to monitor LP-WUS occasion 410-3 and a fourth subgroup can be configured to monitor LP-WUS 410-4 at a same frequency. In some examples, LP-WUS occasion 410-1 and LP-WUS occasion 410-3 can be configured with time gap 420-1, and LP-WUS occasion 410-2 and LP-WUS 410-4 can be configured with time gap 420-2. In some examples, subgroups 1 and 3 can monitor LP-WUS occasions 410-1 and 410-3, observe time gap 420-1, and monitor paging occasion 415.

Subgroups 2 and 4 can monitor LP-WUS occasions 410-2 and 410-4, observe time gap 420-2, and monitor paging occasion 415. Time gap 420-1 can be larger than time gap 420-2, such all four subgroups, regardless of LP-WUS occasion 410 timing, monitor the same paging occasion 415. Subgroups can be assigned based on UE wake-up delay capability. For example, UEs 210 with wake-up delay capabilities greater than time gap 420-2 and less than time gap 420-1 can be assigned to either LP-WUS occasion 410-1 or 410-3. UEs 210 with wake-up delay capabilities less than time gap 420-2 can be configured with any of the LP-WUS occasion 410.

In some examples, a single time gap 420 can be scheduled for one of the LP-WUS occasions 410. Time gaps 420 of the remaining LP-WUS occasions can be determined based on time-frequency resource configuration, offset values, pre-defined rules, etc. For example, LP-WUS occasion 410-1 can be scheduled with time gap 420-1, and the remaining LP-WUS occasions 410-2, 410-2, and 410-4 can be determined to be scheduled according to available time-frequency resources. In some examples, the remaining LP-WUS occasions 410 can be determined by an offset value, such as by being scheduled a specified time before or after LP_WUS occasion 410. In some examples, the remaining LP-WUS occasions 410 can be determined based on a pre-defined rule, such as time gap 420 minimums or maximums. Some pre-defined rules can be used for a UE to determine which of the LOs to monitor, which may depend on the UE ID, the number of LP-WUS occasions, etc.

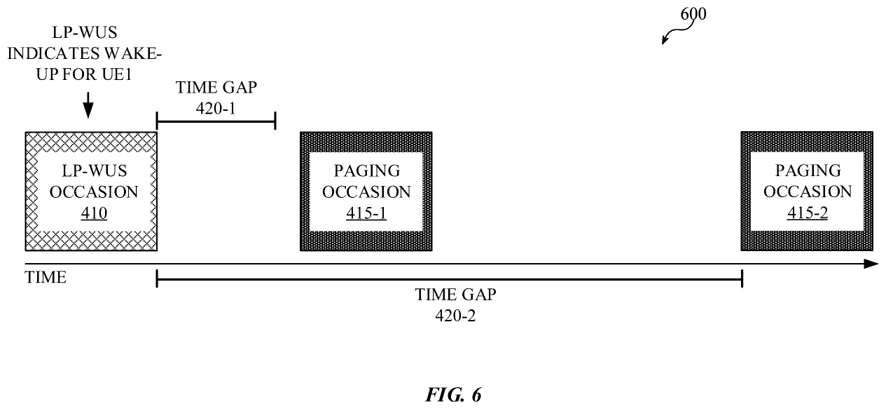

FIG. 6 is a diagram of an example 600 for supporting UE wake-up capabilities according to one or more implementations described herein. Implementations as described with reference to FIG. 6 can implement and be implemented by other figures described herein. FIG. 6 describes a single LP-WUS occasion 410 configured with multiple paging occasions 415. For example, LP-WUS occasion 410 can be configured with time gap 420-1 associated with paging occasion 415-1, and time gap 420-2 associated with paging occasion 415-2 can be automatically derived.

In some examples, a first group or subgroup of UEs 210 can be configured to monitor LP-WUS occasion 410 and paging occasion 410-1, and a second group or subgroup of UEs 210 can be configured to monitor LP-WUS occasion 410 and paging occasion 415-2; that is, both groups or subgroups of UEs 210 can monitor the same LO but observe different time gaps between LP-WUS occasions and paging occasions. In some examples, a singular UE 210, which can be identified as UE1, can monitor LP-WUS occasion 410. UE1 can be example of any UE 210. In some examples, UE1 can determine whether to monitor LP-WUS occasion 410. For example, UE 210 can monitor LP-WUS occasion 410 when one or more values of UE1's wake-up delay capabilities are equal to or shorter than time gap 420-1. In some examples, UE1 can use other conditions or factors to determine whether to monitor LP-WUS occasion 410. When UE1 determines to monitor LP-WUS occasion 410, UE1 can receive a LP-WUS indicating for UE1 to wake-up. After receiving the LP-WUS indicating a wake-up, UE1 can monitor paging occasion 415-1 immediately following LP-WUS occasion 410. In such examples, time gap 420-1 can be longer than or equal to one or more values of UE1's wake-up delay capabilities.

In some examples, UE1's wake-up delay capabilities can be longer than time gap 420-1, and UE1 may not wake up in time to receive paging occasion 415-1 after receiving a LP-WUS during LP-WUS occasion 410. In this case, UE1 may not monitor LP-WUS occasion 410, and can follow a legacy procedure to monitor paging occasion 415. A legacy procedure can include waking at specific time instances to monitor for paging messages without receiving a LP-WUS. Such paging messages can be received according to scheduled physical downlink shared channel (PDSCH) transmissions.

Base station 222 can receive UE capability information, such as part of a UE wake-up delay capability report, determining that UE1 may not monitor LP-WUS occasion(s) 410 based on the UE capability report and the LP-WUS configurations provided by the base station 222. Base station 222 may not transmit the LP-WUS but can instead indicate legacy paging to UE1. For example, base station 222 can indicate for UE 210 to wake at specific time instances via downlink control information (DCI) of a PDCCH. UE 210 can decode the corresponding PDSCH to decode the paging message. In some implementations, paging occasions 415-1 and 415-2 can be monitored by different UE groups.

In some examples, when wake-up delay capabilities of UE1 are longer than time gap 420-1, UE1 can monitor paging occasion 415-2, which can be the paging occasion 415 immediately following expiration of a wake-up delay of UE1 (e.g., the second paging occasion 415-2 after the LP-WUS occasion 410). Base station 222 can include legacy paging for UE1 as part of a paging message of paging occasion 415-2. In some implementations, paging occasions 415-1 and 415-2 can be monitored by the same UE group.

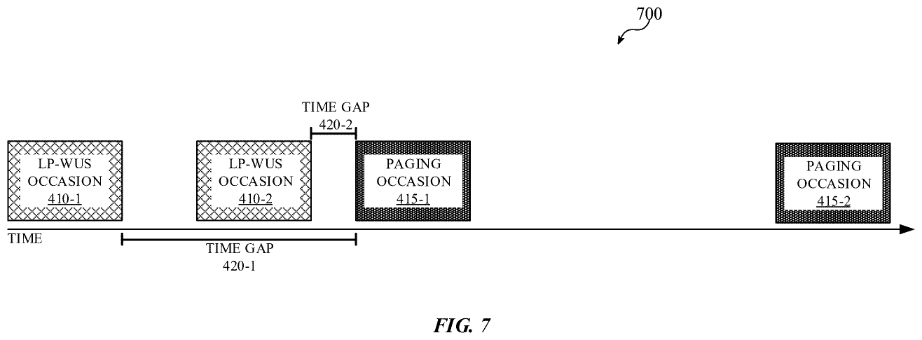

FIG. 7 is a diagram of an example 700 for supporting UE wake-up capabilities according to one or more implementations described herein. FIG. 7 can describe multiple candidate LP-WUS occasion 410 scheduled for a group or subgroups of UEs 210, where each group or subgroup can observe different time gaps 420 relative to paging occasion 415-1. Base station 222 can configure time gaps 420, transmit LP-WUS occasions 410, and transmit paging messages based on wake-up delay capabilities of UE 210. In some examples, each UE 210 can choose which LP-WUS occasion 410 to monitor based on supported wake-up delay values.

In some examples, UE's 210 wake-up delay capabilities can be longer than time gaps 420-1 and 420-2, and UE1 may not wake in time to receive paging occasion 415-1. In some examples, UE 210 may not monitor LP-WUS occasion 410-1 or LP-WUS occasion 410-2 but can instead follow a legacy procedure to monitor paging occasions 415. Base station 222 can receive UE capability information, such as a UE wake-up delay capability report, determining that UE 210 may not monitor LP-WUS occasions 410 for LP-WUSs. In such scenarios, base station 222 may not transmit LP-WUSs but can instead indicate legacy paging using a PDCCH and/or PDSCH.

In some examples, when UE 210 wake-up delay capabilities are longer than time gaps 420-1 and 420-2, UE 210 can monitor LP-WUS occasion 410 based on a pre-defined rule. The pre-defined rule can be received from base station 222 as configuration information. In some examples, UE 210 can monitor LP-WUS occasion 410 with the largest time gap, LP-WUS occasion 410 with the smallest time gap, or LP-WUS occasion 410 that is determined based on a UE identifier (ID), e.g., using a formula. In such scenarios, both UE 210 and base station 222 can be aware of the UE ID. When UE 210 receives a LP-WUS, UE 210 can monitor paging occasion 415 that occurs after expiration of the wake-up delay supported by UE 210. For example, UE 210 can receive a LP-WUS during LP-WUS occasion 410-1 and can monitor paging occasion 415-2 after expiration of the wake-up delay supported by UE 210. In such examples, paging occasion 415-1 occurs prior to the expiration of the wake-up delay supported by UE 210.

In some examples, monitoring LP-WUS occasion 410 with a smallest time gap, LP-WUS occasion 410-2, can be beneficial by reducing paging latency. For example, UE 210 can monitor LP-WUS occasion 415-2, receive a LP-WUS, and because time gap 420-2 is not greater than a wake-up delay supported by UE 210, monitor paging occasion 415-2 instead of paging occasion 415-1.

In some examples, UE 210 can report a single value as part of the UE wake-up delay capability report and can support a value of a wake-up delay that is equal to or smaller than at least one time gap 420 of multiple time gaps 420. In some examples, UE 210 can monitor the LP-WUS occasion 410 with the smallest time gap that is supported by UE 210 and larger than UE's wake-up delay. For example, UE 210 can have a wake-up delay less than or equal to time gap 420-1 and larger than time gap 420-2. In such a scenario, UE 210 can monitor LP-WUS occasion 410-1 and paging occasion 415-1. In some examples, UE 210 can have a wake-up delay less than or equal to time gap 420-2 and can therefore monitor LP-WUS occasion 410-2 and monitor paging occasion 415-1. In some examples, multiple UEs 210 with different capabilities can monitor different LP-WUS occasion 410 and the same paging occasion 415. The LP-WUS occasion 410 can be associated with different time gaps.

In some examples, UE 210 can monitor all LP-WUS occasions 410 with time gaps 420 larger than the supported wake-up delay. For example, UE 210 can support a wake-up delay smaller than time gaps 420-2 and 420-1 and can monitor both LP-WUS occasion 410-1 and 410-2. In such examples, monitoring multiple LP-WUS occasion 410 provides more opportunity for UE 210 to receive LP-WUSs. In some examples, UE 210 can report multiple values of supported wake-up delay, and at least one of the wake-up delay values supported by UE 210 can be equal to or smaller than at least one of time gaps 420. In some examples, there can be N values for UE 210 wake-up delay that is equal to or smaller than at least one of the time gaps 420. In some examples, UE 210 can monitor one LP-WUS occasion 410 based on a pre-defined rule and monitor the paging occasion 415 immediately following LP-WUS occasion 410 when receiving LP-WUS indicating wake-up.

In some examples, a pre-defined rule can include UE 210 monitoring LP-WUS occasion 410 with the smallest time gap 420 that is larger than the largest wake-up delay among the N values, which can result in smaller paging latency. In some examples, the pre-defined rule can include monitoring LP-WUS occasion 410 with the smallest time gap 420 that is still larger than the smallest wake-up delay among the N values, thereby resulting in power savings. For example, UE 210 can support two values for wake-up delay, where the first value is less than or equal to time gap 420-1 and larger than time gap 402-2, and the second value is less than or equal to time gap 420-2. When monitoring according to LP-WUS occasion 410 with the smallest time gap 420 that is larger than the largest wake-up delay among the N values (where, N=2), UE 210 can monitor LP-WUS occasion 410-1 and paging occasion 415-1. When monitoring according to monitoring LP-WUS occasion 410 with the smallest time gap 420 that is larger than the smallest wake-up delay among the N values, UE 210 can monitor LP-WUS occasion 410-2 and paging occasion 415-1.

In some examples, when UE 210 can report multiple values of supported wake-up delay, and at least one of the wake-up delay values supported by UE 210 can be equal to or smaller than at least one of time gaps 420. In such examples, when UE 210 receives a LP-WUS indicating wake-up, UE 210 can monitor one or more LP-WUS occasions 410 based on a pre-defined rule. Additionally, UE 210 can monitor the paging occasion 415 that immediately follows the LP-WUS occasions during which the LP-WUS was received. In some examples, a pre-defined rule can include UE 210 monitoring all LP-WUS occasions 410 with a time gap 420. that is larger than the largest wake-up delay among the N values.

In some examples, a pre-defined rule can include UE 210 monitoring all LP-WUS occasions 410 with a time gap 420 that is larger than the smallest wake-up delay among the N values. Doing so can result in more opportunities to receive an LP-WUS. For example, when monitoring all LP-WUS occasions 410 with the time gap 420 that is larger than the largest wake-up delay among the N values, UE 210 can monitor LP-WUS occasion 410-1. When monitoring LP-WUS occasion occasions 410 with the time gap 420 that is larger than the smallest wake-up delay among the N values, UE 210 can monitor LP-WUS occasion 410-2 and 410-2.

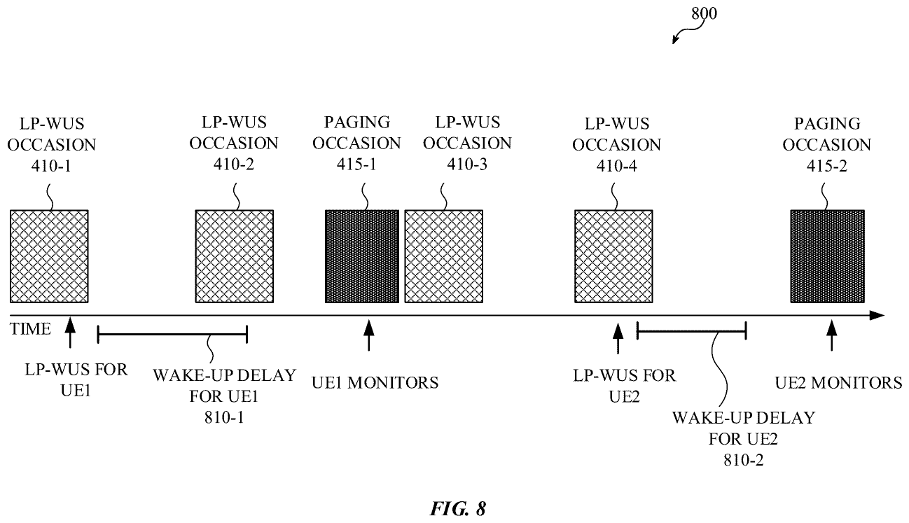

FIG. 8 is a diagram of an example 800 for supporting UE wake-up capabilities according to one or more implementations described herein. FIG. 8 depicts LP-WUS occasions 410 monitored by UE 210. For example, base station 222 can configure one or more LP-WUS occasion 410 to be monitored by UE 210. The LP-WUS occasions monitored by a UE may be configured and determined independently from the paging occasions, e.g. determined using a periodicity and an offset. When UE 210 receives a LP-WUS prompting UE 210 to wake-up, UE 210 can monitor a first paging occasion 415 that is at least as long as the wake-up delay measured from after the corresponding LP-WUS occasion 410-1.

In some examples, different UEs 210 can monitor the same or different LP-WUS occasions 410 and different paging occasions 415. When UE 210 supports multiple values for wake-up delay, base station 222 can configure which wake-up delay is to be used be UE 210 (e.g., a smallest wake-up delay, a largest wake-up delay, etc.). For example, a first UE1 which can be an example of UE 210 and a second UE2 which can be example of UE 210 can be configured to monitor the same or different LP-WUS occasions 410 and paging occasions 415. UE1 can monitor LP-WUS occasion 410-1 and receive LP-WUS. Wake-up delay for UE1 810-1 can be shorter than the time between LP-WUS occasion 410-1 and paging occasion 415-1. UE1 can therefore monitor paging occasion 415-1. In some examples, UE2 can monitor LP-WUS occasion 410-4 and receive a LP-WUS with an indication for UE2 to wake up. A wake-up delay for UE2 810-2 can end prior to paging occasion 415-2, and UE2 can therefore monitor paging occasion 415-2.

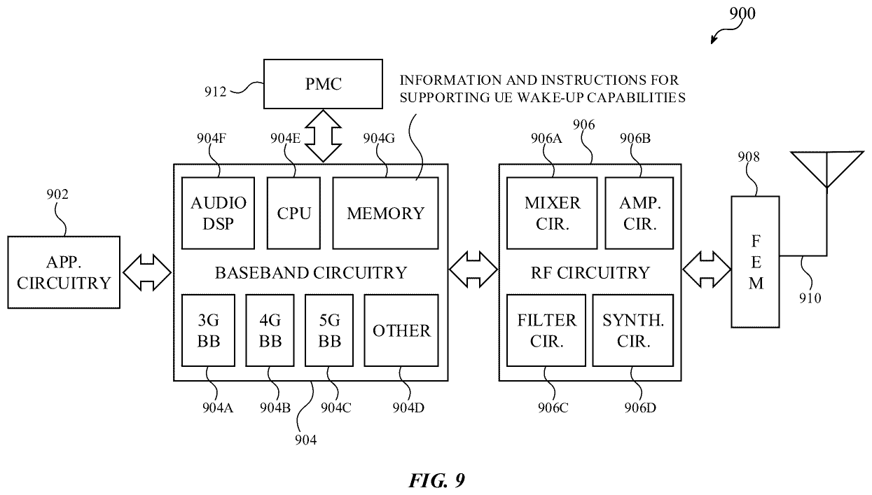

FIG. 9 is a diagram of an example of components of a device according to one or more implementations described herein. In some implementations, the device 900 can include application circuitry 902, baseband circuitry 904, RF circuitry 906, front-end module (FEM) circuitry 908, one or more antennas 910, and power management circuitry (PMC) 912 coupled together at least as shown. The components of the illustrated device 900 can be included in a UE or a RAN node. In some implementations, the device 900 can include fewer elements (e.g., a RAN node may not utilize application circuitry 902, and instead include a processor/controller to process IP data received from a CN or an Evolved Packet Core (EPC)). In some implementations, the device 900 can include additional elements such as, for example, memory/storage, display, camera, sensor (including one or more temperature sensors, such as a single temperature sensor, a plurality of temperature sensors at different locations in device 900, etc.), or input/output (I/O) interface. In other implementations, the components described below can be included in more than one device (e.g., said circuitries can be separately included in more than one device for Cloud-RAN (C-RAN) implementations).

The application circuitry 902 can include one or more application processors. For example, the application circuitry 902 can include circuitry such as, but not limited to, one or more single-core or multi-core processors. The processor(s) can include any combination of general-purpose processors and dedicated processors (e.g., graphics processors, application processors, etc.). The processors can be coupled with or can include memory/storage and can be configured to execute instructions stored in the memory/storage to enable various applications or operating systems to run on the device 900. In some implementations, processors of application circuitry 902 can process IP data packets received from an EPC.

The baseband circuitry 904 can include circuitry such as, but not limited to, one or more single-core or multi-core processors. The baseband circuitry 904 can include one or more baseband processors or control logic to process baseband signals received from a receive signal path of the RF circuitry 906 and to generate baseband signals for a transmit signal path of the RF circuitry 906. Baseband circuity 904 can interface with the application circuitry 902 for generation and processing of the baseband signals and for controlling operations of the RF circuitry 906. For example, in some implementations, the baseband circuitry 904 can include a 3G baseband processor 904A, a 4G baseband processor 904B, a 5G baseband processor 904C, or other baseband processor(s) 904D for other existing generations, generations in development or to be developed in the future (e.g., 5G, 6G, etc.). The baseband circuitry 904 (e.g., one or more of baseband processors 904A-D) can handle various radio control functions that enable communication with one or more radio networks via the RF circuitry 906. In other implementations, some or all of the functionality of baseband processors 904A-D can be included in modules stored in the memory 904G and executed via a Central Processing Unit (CPU) 904E. The radio control functions can include, but are not limited to, signal modulation/demodulation, encoding/decoding, radio frequency shifting, etc. In some implementations, modulation/demodulation circuitry of the baseband circuitry 904 can include Fast-Fourier Transform (FFT), precoding, or constellation mapping/de-mapping functionality. In some implementations, encoding/decoding circuitry of the baseband circuitry 904 can include convolution, tail-biting convolution, turbo, Viterbi, or Low-Density Parity Check (LDPC) encoder/decoder functionality. Implementations of modulation/demodulation and encoder/decoder functionality are not limited to these examples and can include other suitable functionality in other implementations.

In some implementations, memory 904G can receive and/or store information and instructions for enabling UE 210, and/or one or more components thereof, to support UE wake-up delay capabilities. For example, information and instructions can include enabling UE 210 to indicate a wake-up delay capability report to base station 222. Base station 222 can, based on one or more reports from one or more UEs 210, assign each UE 210 to a group or subgroup, and configure each UE 210 accordingly. UE 210 can monitor LP-WUS occasions and paging occasions based on the configuration.

In some implementations, the baseband circuitry 904 can include one or more audio digital signal processor(s) (DSP) 904F. The audio DSPs 904F can include elements for compression/decompression and echo cancellation and can include other suitable processing elements in other implementations. Components of the baseband circuitry can be suitably combined in a single chip, a single chipset, or disposed on a same circuit board in some implementations. In some implementations, some or all of the constituent components of the baseband circuitry 904 and the application circuitry 902 can be implemented together such as, for example, on a system on a chip (SOC).

In some implementations, the baseband circuitry 904 can provide for communication compatible with one or more radio technologies. For example, in some implementations, the baseband circuitry 904 can support communication with a NG-RAN, an evolved universal terrestrial radio access network (EUTRAN) or other wireless metropolitan area networks (WMAN), a wireless local area network (WLAN), a wireless personal area network (WPAN), etc. Implementations in which the baseband circuitry 904 is configured to support radio communications of more than one wireless protocol can be referred to as multi-mode baseband circuitry.

RF circuitry 906 can enable communication with wireless networks using modulated electromagnetic radiation through a non-solid medium. In various implementations, the RF circuitry 906 can include switches, filters, amplifiers, etc. to facilitate the communication with the wireless network. RF circuitry 906 can include a receive signal path which can include circuitry to down-convert RF signals received from the FEM circuitry 908 and provide baseband signals to the baseband circuitry 904. RF circuitry 906 can also include a transmit signal path which can include circuitry to up-convert baseband signals provided by the baseband circuitry 904 and provide RF output signals to the FEM circuitry 908 for transmission.

In some implementations, the receive signal path of the RF circuitry 906 can include mixer circuitry 906A, amplifier circuitry 906B and filter circuitry 906C. In some implementations, the transmit signal path of the RF circuitry 906 can include filter circuitry 906C and mixer circuitry 906A. RF circuitry 906 can also include synthesizer circuitry 906D for synthesizing a frequency for use by the mixer circuitry 906A of the receive signal path and the transmit signal path. In some implementations, the mixer circuitry 906A of the receive signal path can be configured to down-convert RF signals received from the FEM circuitry 908 based on the synthesized frequency provided by synthesizer circuitry 906D. The amplifier circuitry 906B can be configured to amplify the down-converted signals and the filter circuitry 906C can be a low-pass filter (LPF) or band-pass filter (BPF) configured to remove unwanted signals from the down-converted signals to generate output baseband signals. Output baseband signals can be provided to the baseband circuitry 904 for further processing. In some implementations, the output baseband signals can be zero-frequency baseband signals, although this is not a requirement. In some implementations, mixer circuitry 906A of the receive signal path can comprise passive mixers, although the scope of the implementations is not limited in this respect.

In some implementations, the mixer circuitry 906A of the transmit signal path can be configured to up-convert input baseband signals based on the synthesized frequency provided by the synthesizer circuitry 906D to generate RF output signals for the FEM circuitry 908. The baseband signals can be provided by the baseband circuitry 904 and can be filtered by filter circuitry 906C.

In some implementations, the mixer circuitry 906A of the receive signal path and the mixer circuitry 906A of the transmit signal path can include two or more mixers and can be arranged for quadrature down conversion and up conversion, respectively. In some implementations, the mixer circuitry 906A of the receive signal path and the mixer circuitry 906A of the transmit signal path can include two or more mixers and can be arranged for image rejection (e.g., Hartley image rejection). In some implementations, the mixer circuitry 906A of the receive signal path and the mixer circuitry 906A can be arranged for direct down conversion and direct up conversion, respectively. In some implementations, the mixer circuitry 906A of the receive signal path and the mixer circuitry 906A of the transmit signal path can be configured for super-heterodyne operation.

In some implementations, the output baseband signals, and the input baseband signals can be analog baseband signals, although the scope of the implementations is not limited in this respect. In some alternate implementations, the output baseband signals, and the input baseband signals can be digital baseband signals. In these alternate implementations, the RF circuitry 906 can include analog-to-digital converter (ADC) and digital-to-analog converter (DAC) circuitry and the baseband circuitry 904 can include a digital baseband interface to communicate with the RF circuitry 906.

In some dual-mode implementations, a separate radio IC circuitry can be provided for processing signals for each spectrum, although the scope of the implementations is not limited in this respect.

In some implementations, the synthesizer circuitry 906D can be a fractional-N synthesizer or a fractional N/N+1 synthesizer, although the scope of the implementations is not limited in this respect as other types of frequency synthesizers can be suitable. For example, synthesizer circuitry 906D can be a delta-sigma synthesizer, a frequency multiplier, or a synthesizer comprising a phase-locked loop with a frequency divider.

The synthesizer circuitry 906D can be configured to synthesize an output frequency for use by the mixer circuitry 906A of the RF circuitry 906 based on a frequency input and a divider control input. In some implementations, the synthesizer circuitry 906D can be a fractional N/N+1 synthesizer.

In some implementations, frequency input can be provided by a voltage-controlled oscillator (VCO), although that is not a requirement. Divider control input can be provided by either the baseband circuitry 904 or the applications circuitry 902 depending on the desired output frequency. In some implementations, a divider control input (e.g., N) can be determined from a look-up table based on a channel indicated by the applications circuitry 902.

Synthesizer circuitry 906D of the RF circuitry 906 can include a divider, a delay-locked loop (DLL), a multiplexer and a phase accumulator. In some implementations, the divider can be a dual modulus divider (DMD) and the phase accumulator can be a digital phase accumulator (DPA). In some implementations, the DMD can be configured to divide the input signal by either N or N+1 (e.g., based on a carry out) to provide a fractional division ratio. In some example implementations, the DLL can include a set of cascaded, tunable, delay elements, a phase detector, a charge pump and a D-type flip-flop. In these implementations, the delay elements can be configured to break a VCO period up into Nd equal packets of phase, where Nd is the number of delay elements in the delay line. In this way, the DLL provides negative feedback to help ensure that the total delay through the delay line is one VCO cycle.

In some implementations, synthesizer circuitry 906D can be configured to generate a carrier frequency as the output frequency, while in other implementations, the output frequency can be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some implementations, the output frequency can be a LO frequency (fLO). In some implementations, the RF circuitry 906 can include an IQ/polar converter.

FEM circuitry 908 can include a receive signal path which can include circuitry configured to operate on RF signals received from one or more antennas 910, amplify the received signals and provide the amplified versions of the received signals to the RF circuitry 906 for further processing. FEM circuitry 908 can also include a transmit signal path which can include circuitry configured to amplify signals for transmission provided by the RF circuitry 906 for transmission by one or more of the one or more antennas 910. In various implementations, the amplification through the transmit or receive signal paths can be done solely in the RF circuitry 906, solely in the FEM circuitry 908, or in both the RF circuitry 906 and the FEM circuitry 908.

In some implementations, the FEM circuitry 908 can include a TX/RX switch to switch between transmit mode and receive mode operation. The FEM circuitry can include a receive signal path and a transmit signal path. The receive signal path of the FEM circuitry can include an LNA to amplify received RF signals and provide the amplified received RF signals as an output (e.g., to the RF circuitry 906). The transmit signal path of the FEM circuitry 908 can include a power amplifier (PA) to amplify input RF signals (e.g., provided by RF circuitry 906), and one or more filters to generate RF signals for subsequent transmission (e.g., by one or more of the one or more antennas 910).

In some implementations, the PMC 912 can manage power provided to the baseband circuitry 904. In particular, the PMC 912 can control power-source selection, voltage scaling, battery charging, or DC-to-DC conversion. The PMC 912 can often be included when the device 900 is capable of being powered by a battery, for example, when the device is included in a UE. The PMC 912 can increase the power conversion efficiency while providing desirable implementation size and heat dissipation characteristics.

While FIG. 9 shows the PMC 912 coupled only with the baseband circuitry 904. However, in other implementations, the PMC 912 can be additionally or alternatively coupled with, and perform similar power management operations for, other components such as, but not limited to, application circuitry 902, RF circuitry 906, or FEM circuitry 908.

In some implementations, the PMC 912 can control, or otherwise be part of, various power saving mechanisms of the device 900. For example, if the device 900 is in an RRC_Connected state, where it is still connected to the RAN node as it expects to receive traffic shortly, then it can enter a state known as discontinuous reception mode (DRX) after a period of inactivity. During this state, the device 900 can power down for brief intervals of time and thus save power.

If there is no data traffic activity for an extended period of time, then the device 900 can transition off to an RRC_Idle state, where it disconnects from the network and does not perform operations such as channel quality feedback, handover, etc. The device 900 goes into a very low power state and it performs paging where again it periodically wakes up to listen to the network and then powers down again. The device 900 may not receive data in this state; in order to receive data, it can transition back to RRC_Connected state.

An additional power saving mode can allow a device to be unavailable to the network for periods longer than a paging interval (ranging from seconds to a few hours). During this time, the device is unreachable to the network and can power down completely. Any data sent during this time incurs a large delay and it is assumed the delay is acceptable.

Processors of the application circuitry 902 and processors of the baseband circuitry 904 can be used to execute elements of one or more instances of a protocol stack. For example, processors of the baseband circuitry 904, alone or in combination, can be used execute Layer 3, Layer 2, or Layer 1 functionality, while processors of the baseband circuitry 904 can utilize data (e.g., packet data) received from these layers and further execute Layer 4 functionality (e.g., transmission communication protocol (TCP) and user datagram protocol (UDP) layers). As referred to herein, Layer 3 can comprise a RRC layer, described in further detail below. As referred to herein, Layer 2 can comprise a medium access control (MAC) layer, a radio link control (RLC) layer, and a packet data convergence protocol (PDCP) layer, described in further detail below. As referred to herein, Layer I can comprise a physical (PHY) layer of a UE/RAN node, described in further detail below.

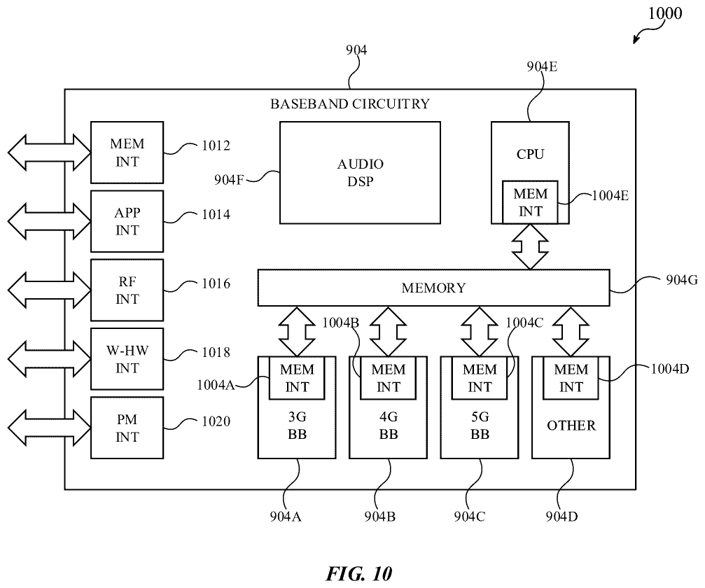

FIG. 10 is a diagram of example interfaces 1000 of baseband circuitry according to one or more implementations described herein. As discussed above, the baseband circuitry 904 of FIG. 9 can comprise processors 904A through 904E and a memory 904G utilized by said processors. Each of the processors 904A through 904E can include a memory interface, 1040A through 1040E, respectively, to send/receive data to/from the memory 904G.

In some implementations, memory 904G can receive, store, and/or provide information and instructions for supporting UE wake-up delay capabilities. For example, information and instructions can include enabling UE 210 to indicate a wake-up delay capability report to base station 222. Base station 222 can, based on one or more reports from one or more UEs 210, assign each UE 210 to a group or subgroup, and configure each UE 210 accordingly. UE 210 can monitor LP-WUS occasions and paging occasions based on the configuration.

The baseband circuitry 904 can further include one or more interfaces to communicatively couple to other circuitries/devices, such as a memory interface 1012 (e.g., an interface to send/receive data to/from memory external to the baseband circuitry 904), an application circuitry interface 1014 (e.g., an interface to send/receive data to/from the application circuitry 902 of FIG. 9), an RF circuitry interface 1016 (e.g., an interface to send/receive data to/from RF circuitry 906 of FIG. 9), a wireless hardware connectivity interface 1018 (e.g., an interface to send/receive data to/from Near Field Communication (NFC) components, Bluetooth® components (e.g., Bluetooth® Low Energy), Wi-Fi® components, and other communication components), and a power management interface 1020 (e.g., an interface to send/receive power or control signals to/from the PMC 912).

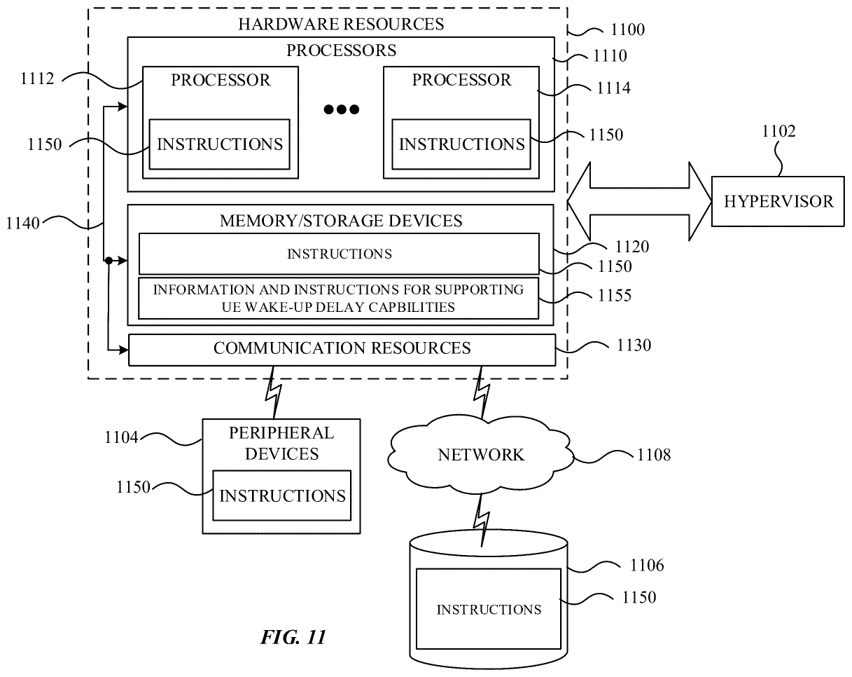

FIG. 11 is a block diagram illustrating components, according to some example implementations, able to read instructions from a machine-readable or computer-readable medium (e.g., a non-transitory machine-readable storage medium) and perform any one or more of the methodologies discussed herein. Specifically, FIG. 11 shows a diagrammatic representation of hardware resources 1100 including one or more processors (or processor cores) 1110, one or more memory/storage devices 1110, and one or more communication resources 1130, each of which can be communicatively coupled via a bus 1140. For implementations where node virtualization (e.g., NFV) is utilized, a hypervisor 1102 can be executed to provide an execution environment for one or more network slices/sub-slices to utilize the hardware resources 1100.

The processors 1110 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) can include, for example, a processor 1112 and a processor 1114. Processor 1112 and processor 1114 can include instructions 1150.

The memory/storage devices 1110 can include main memory, disk storage, or any suitable combination thereof. The memory/storage devices 1110 can include, but are not limited to any type of volatile or non-volatile memory such as dynamic random-access memory (DRAM), static random-access memory (SRAM), erasable programmable read-only memory (EPROM), electrically erasable programmable read-only memory (EEPROM), Flash memory, solid-state storage, etc.

In some implementations, memory/storage devices 1110 receive and/or store information and instructions 1155 for supporting UE wake-up delay capabilities. For example, information and instructions can include enabling UE 210 to indicate a wake-up delay capability report to base station 222. Base station 222 can, based on one or more reports from one or more UEs 210, assign each UE 210 to a group or subgroup, and configure each UE 210 accordingly. UE 210 can monitor LP-WUS occasions and paging occasions based on the configuration.

The communication resources 1130 can include interconnection or network interface components or other suitable devices to communicate with one or more peripheral devices 1104 or one or more databases 1106 via a network 1108. For example, the communication resources 1130 can include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions 1150 can comprise software, a program, an application, an applet, an app, or other executable code for causing at least any of the processors 1110 to perform any one or more of the methodologies discussed herein. The instructions 1150 can reside, completely or partially, within at least one of the processors 1110 (e.g., within the processor's cache memory), the memory/storage devices 1110, or any suitable combination thereof. Furthermore, any portion of the instructions 1150 can be transferred to the hardware resources 1100 from any combination of the peripheral devices 1104 or the databases 1106. Accordingly, the memory of processors 1110, the memory/storage devices 1110, the peripheral devices 1104, and the databases 1106 are examples of computer-readable and machine-readable media.

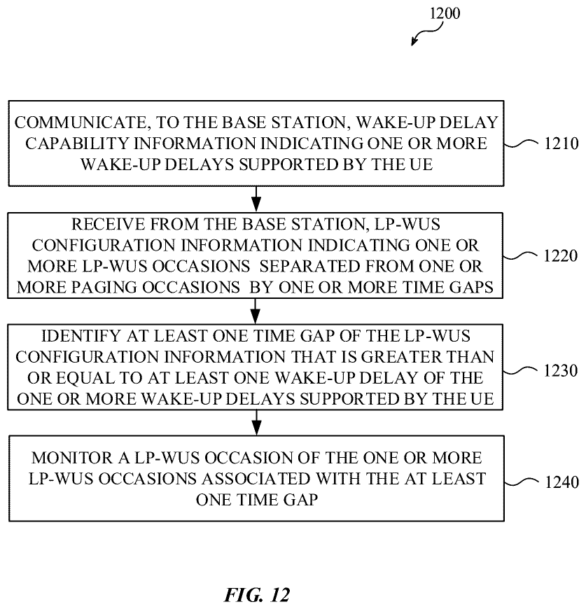

FIG. 12 is a diagram of an example process for supporting UE wake-up delay according to one or more implementations described herein. Process 1200 can be implemented by UE 210. In some implementations, some or all of process 1200 can be performed by one or more other systems or devices, including one or more of the devices of FIG. 2. Additionally, process 1200 can include one or more fewer, additional, differently ordered and/or arranged operations than those shown in FIG. 12. In some implementations, some or all of the operations of process 1200 can be performed independently, successively, simultaneously, etc., of one or more of the other operations of process 1200. As such, the techniques described herein are not limited to a number, sequence, arrangement, timing, etc., of the operations or processes depicted in FIG. 12.

Process 1200 can include communicating, to base station 222, wake-up delay capability information indicating one or more wake-up delays supported by the UE 210 (block 1210). Process 1200 can include receiving, from the base station, LP-WUS configuration information indicating one or more LP-WUS occasions separated from one or more paging occasions by one or more time gaps (block 1220). Process 1200 can include identifying at least one time gap of the LP-WUS configuration information that is greater than or equal to at least one wake-up delay of the one or more wake-up delays supported by UE 210 (block 1230). Process 1200 can include monitoring a LP-WUS occasion of the one or more LP-WUS occasions associated with the at least one time gap.

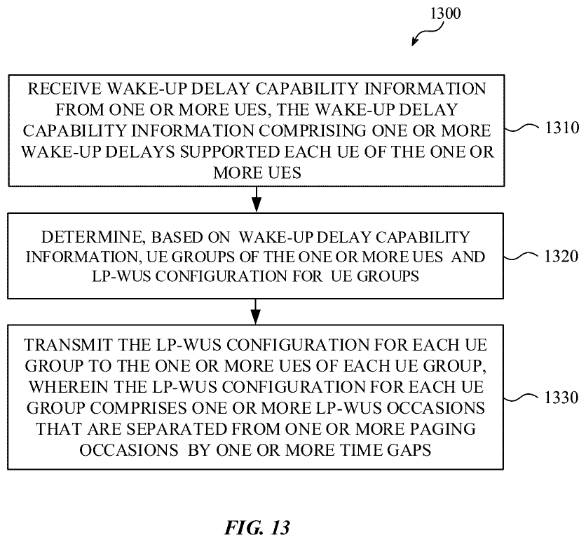

FIG. 13 is a diagram of an example process for supporting UE wake-up delay according to one or more implementations described herein. Process 1300 can be implemented by base station 222. In some implementations, some or all of process 1300 can be performed by one or more other systems or devices, including one or more of the devices of FIG. 2. Additionally, process 1300 can include one or more fewer, additional, differently ordered and/or arranged operations than those shown in FIG. 13. In some implementations, some or all of the operations of process 1300 can be performed independently, successively, simultaneously, etc., of one or more of the other operations of process 1300. As such, the techniques described herein are not limited to a number, sequence, arrangement, timing, etc., of the operations or processes depicted in FIG. 13.

Process 1300 can include receiving wake-up delay capability information from one or more UEs 210, the wake-up delay capability information including one or more wake-up delays supported by each UE 210 of the one or more UEs 210 (block 1310). Process 1300 can include determining, based on the wake-up delay capability information, UE groups of the one or more UEs 210 and the LP-WUS configuration for the UE groups (block 1320). The LP-WUS configuration message can be common for all UEs 210, and each UE 210 or UE group can figure out which LOs to monitor based on the LP-WUS configuration. Process 1300 can include transmitting the LP-WUS configuration for the UE groups to the one or more UEs 210 of each UE group, where the LP-WUS configuration includes one or more LP-WUS occasions that are separated from one or more paging occasions by one or more time gaps (block 1330) for each UE group.

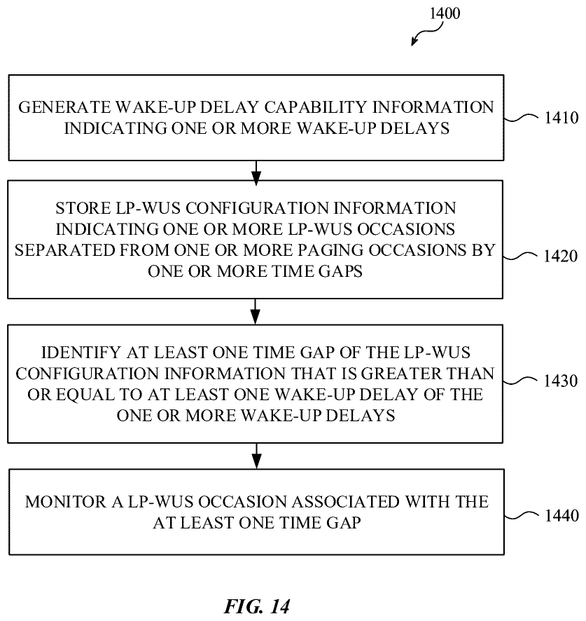

FIG. 14 is a diagram of an example process for supporting UE wake-up delay according to one or more implementations described herein. Process 1400 can be implemented by baseband circuitry. In some implementations, some or all of process 1400 can be performed by one or more other systems or devices, including one or more of the devices of FIG. 2. Additionally, process 1400 can include one or more fewer, additional, differently ordered and/or arranged operations than those shown in FIG. 14. In some implementations, some or all of the operations of process 1400 can be performed independently, successively, simultaneously, etc., of one or more of the other operations of process 1400. As such, the techniques described herein are not limited to a number, sequence, arrangement, timing, etc., of the operations or processes depicted in FIG. 14.

Process 1400 can include generating wake-up delay capability information indicating one or more wake-up delays (block 1410). Process 1400 can include storing LP-WUS configuration information indicating one or more LP-WUS occasions separated from one or more paging occasions by one or more time gaps (block 1420). Process 1400 can include identifying at least one time gap of the LP-WUS configuration information that is greater than or equal to at least one wake-up delay of the one or more wake-up delays (block 1430). Process 1400 can include monitoring a LP-WUS occasion associated with the at least one time gap (block 1440).

Examples and/or implementations herein can include subject matter such as a method, means for performing acts or blocks of the method, at least one machine-readable medium including executable instructions that, when performed by a machine (e.g., a processor (e.g., processor, etc.) with memory, an application-specific integrated circuit (ASIC), a field programmable gate array (FPGA), or the like) cause the machine to perform acts of the method or of an apparatus or system for concurrent communication using multiple communication technologies according to implementations and examples described.

In example 1, which can also include one or more of the examples described herein, a user device (UE) can comprise a memory; and one or more processors configured to, when executing instructions stored in the memory, cause the UE to: communicate, to a base station, wake-up delay capability information indicating one or more wake-up delays supported by the UE; receive, from the base station, low-power wake-up signal (LP-WUS) configuration information indicating one or more LP-WUS occasions (LOs) separated from one or more paging occasions (POs) by one or more time gaps; identify at least one time gap of the LP-WUS configuration information that is greater than or equal to at least one wake-up delay of the one or more wake-up delays supported by the UE; and monitor an LO of the one or more LOs associated with the at least one time gap.

In example 2, which can also include one or more of the examples described herein, the LP-WUS configuration information comprises an indication of one LO, and the one or more processors are further configured to cause the UE to: receive a LP-WUS during the one LO; transition out of a power saving mode in response to the LP-WUS, and monitor one PO based on the LP-WUS configuration information.

In example 3, which can also include one or more of the examples described herein, the UE is part of a UE group or a UE subgroup, and the LP-WUS configuration information is configured for the UE group or the UE subgroup.

In example 4, which can also include one or more of the examples described herein, the one LO and the PO are separated by a time gap greater than or equal to the at least one wake-up delay.

In example 5, which can also include one or more of the examples described herein, the one or more processors are further configured to cause the UE to: refrain from monitoring the one LO based on a time gap between the LO and the PO being less than the at least one wake-up delay; and monitor the PO without receiving the LP-WUS.

In example 6, which can also include one or more of the examples described herein, the LP-WUS configuration information comprises an indication of at least two LOs and one PO with different time gaps between each of the at least two LOs and the one PO, and the one or more processors are further configured to cause the UE to: determine which of the at least two LOs to monitor based on the at least one wake-up delay.

In example 7, which can also include one or more of the examples described herein, the LP-WUS configuration information comprises an indication of one LO and at least two POs with different time gaps between the one LO and each of the at least two POs.

In example 8, which can also include one or more of the examples described herein, the LP-WUS configuration further comprises an indication of one LO, a first PO, and a second PO, the LP-WUS configuration information is configured for a UE group or UE subgroup, and the one or more processors are further configured to cause the UE to: receive, during the LO, a LP-WUS; refrain from monitoring the first PO based on a first time gap between the LO and the first PO being shorter than the one or more wake-up delays supported by the UE; and monitor the second PO based on a second time gap between the LO and the second PO being longer than the one or more wake-up delays supported by the UE.

In example 9, which can also include one or more of the examples described herein, a largest time gap between the one or more LOs and the one or more POs is less than a largest wake-up delay supported by the UE, and the one or more processors are further configured to cause the UE to: refrain from monitoring the one or more LOs; and monitor at least one PO of the one or more POs without receiving a LP-WUS.

In example 10, which can also include one or more of the examples described herein, a largest time gap between the one or more LOs and the one or more POs is less than a largest wake-up delay supported by the UE, and the one or more processors are further configured to cause the UE to: monitor at least one LO of the of the one or more LOs; and receive, during the at least one LO, a LP-WUS; refrain from monitoring a first PO, of the one or more POs, based on a first time gap between the LP-WUS and the first PO being shorter than the one or more wake-up delays supported by the UE; and monitor a second PO, of the one or more POs, based on a second time gap between the LP-WUS and the second PO being longer than the one or more wake-up delays supported by the UE.

In example 11, which can also include one or more of the examples described herein, the at least one LO is a predefined LO associated with a largest time gap, a smallest time gap, or is determined based on an ID of the UE.

In example 12, which can also include one or more of the examples described herein, the one or more processors are further configured to cause the UE to: receive a LP-WUS during a LO of the one or more LOs; and monitor a first PO, of the one or more POs, occurring after the at least one wake-up delay, the LO being determined by the UE independent of the first PO.

In example 13, which can also include one or more of the examples described herein, different wake-up delays, of the one or more wake-up delays indicated by the wake-up delay capability information, correspond to different power saving modes of the UE.

In example 14, which can also include one or more of the examples described herein, a base station can comprise: a memory; and one or more processors configured to, when executing instructions stored in the memory, cause the base station to: receive wake-up delay capability information from one or more user equipment (UEs), the wake-up delay capability information comprising one or more wake-up delays supported by each UE of the one or more UEs; determine, based on the wake-up delay capability information, UE groups of the one or more UEs and a low-power wake-up signal (LP-WUS) configuration for each UE group; and transmit the LP-WUS configuration for each UE group to the one or more UEs of each UE group, wherein the LP-WUS configuration for each UE group comprises one or more LP-WUS occasions (LOs) that are separated from one or more paging occasions (POs) by one or more time gaps.

In example 15, which can also include one or more of the examples described herein, the one or more processors are further configured to cause the base station to: transmit a LP-WUS during an LO of the one or more LOs to the one or more UEs of each UE group of the UE groups based on the LP-WUS configuration for each UE group.

In example 16, which can also include one or more of the examples described herein, the one or more processors are further configured to cause the base station to: refrain from transmitting a LP-WUS based on a time gap of the one or more time gaps between a LO of thee one or more LOs and a PO of the one or more POs being shorter than the one or more wake-up delays supported by each UE of the one or more UEs; and transmit a paging message based on refraining from transmitting the LP-WUS.

In example 17, which can also include one or more of the examples described herein, the LP-WUS configuration for each UE group comprises a first LP-WUS configuration for a first UE group of the UE groups and a second LP-WUS configuration for a second UE group of the UE groups, the one or more processors are further configured to cause the base station to: transmit the first LP-WUS configuration to the first UE group, the first LP-WUS configuration comprising an indication of a first LO and a first PO; transmit the second LP-WUS configuration to the second UE group, the second LP-WUS configuration comprising an indication of a second LO and a second PO; transmit a first LP-WUS during the first LO indicating for the first UE group to wake up and monitor the first PO; and transmit a second LP-WUS during the second LO indicating for the second UE group to wake up and monitor the second PO.

In example 18, which can also include one or more of the examples described herein, the LP-WUS configuration for each UE group comprises a first LP-WUS configuration for a first UE group of the UE groups and a second IP-WUS configuration for a second UE group of the UE groups, the one or more processors are further configured to cause the base station to: transmit the first LP-WUS configuration to the first UE group, the first LP-WUS configuration comprising an indication of a first LO and a first PO; transmit the second LP-WUS configuration to the second UE group, the second LP-WUS configuration comprising an indication of a second LO and the first PO; transmit a first LP-WUS during the first LO indicating for the first UE group to wake up and monitor the first PO; and transmit a second LP-WUS during the second LO indicating for the second UE group to wake up and monitor the first PO.

In example 19, which can also include one or more of the examples described herein, the one or more processors are further configured to cause the base station to: transmit, to a UE group of the UE groups, the LP-WUS configuration further comprising an indication of multiple LOs and a PO; and transmit, to the UE group, multiple LP-WUSs according to the multiple LOs and the PO.

In example 20, which can also include one or more of the examples described herein, baseband circuitry can comprise: a memory; and one or more processors configured to, when executing instructions stored in the memory, cause the baseband circuitry to: generate wake-up delay capability information indicating one or more wake-up delays; store low-power wake-up signal (LP-WUS) configuration information indicating one or more LP-WUS occasions (LOs) separated from one or more paging occasions (POs) by one or more time gaps; identify at least one time gap of the LP-WUS configuration information that is greater than or equal to at least one wake-up delay of the one or more wake-up delays; and monitor a LO associated with the at least one time gap.

The examples discussed above also extend to method, computer-readable medium, and means-plus-function claims and implementations, any of which can include one or more of the features or operations of any one or combination of the examples mentioned above.

The above description of illustrated examples, implementations, aspects, etc., of the subject disclosure, including what is described in the Abstract, is not intended to be exhaustive or to limit the disclosed aspects to the precise forms disclosed. While specific examples, implementations, aspects, etc., are described herein for illustrative purposes, various modifications are possible that are considered within the scope of such examples, implementations, aspects, etc., as those skilled in the relevant art can recognize.

In this regard, while the disclosed subject matter has been described in connection with various examples, implementations, aspects, etc., and corresponding Figures, where applicable, it is to be understood that other similar aspects can be used or modifications and additions can be made to the disclosed subject matter for performing the same, similar, alternative, or substitute function of the subject matter without deviating therefrom. Therefore, the disclosed subject matter should not be limited to any single example, implementation, or aspect described herein, but rather should be construed in breadth and scope in accordance with the appended claims below.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations. In addition, while a particular feature can have been disclosed with respect to only one of several implementations, such feature can be combined with one or more other features of the other implementations as can be desired and advantageous for any given application.

As used herein, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description or the claims, such terms are intended to be inclusive in a manner similar to the term “comprising.” Additionally, in situations wherein one or more numbered items are discussed (e.g., a “first X”, a “second X”, etc.), in general the one or more numbered items can be distinct, or they can be the same, although in some situations the context can indicate that they are distinct or that they are the same.

It is well understood that the use of personally identifiable information should follow privacy policies and practices that are generally recognized as meeting or exceeding industry or governmental requirements for maintaining the privacy of users. In particular, personally identifiable information data should be managed and handled to minimize risks of unintentional or unauthorized access or use, and the nature of authorized use should be clearly indicated to users.

What is claimed is:

1. A user equipment (UE), comprising:
a memory; and
one or more processors configured to, when executing instructions stored in the memory, cause the UE to:
communicate, to a base station, wake-up delay capability information indicating one or more wake-up delays supported by the UE;
receive, from the base station, low-power wake-up signal (LP-WUS) configuration information indicating one or more LP-WUS occasions (LOs) separated from one or more paging occasions (POs) by one or more time gaps;
identify at least one time gap of the LP-WUS configuration information that is greater than or equal to at least one wake-up delay of the one or more wake-up delays supported by the UE; and
monitor an LO of the one or more LOs associated with the at least one time gap.

2. The UE of claim 1, wherein:
the LP-WUS configuration information comprises an indication of one LO, and
the one or more processors are further configured to cause the UE to:
receive a LP-WUS during the one LO;
transition out of a power saving mode in response to the LP-WUS, and monitor one PO based on the LP-WUS configuration information.

3. The UE of claim 2, wherein:
the UE is part of a UE group or a UE subgroup, and
the LP-WUS configuration information is configured for the UE group or the UE subgroup.

4. The UE of claim 2, wherein the one LO and the PO are separated by a time gap greater than or equal to the at least one wake-up delay.

5. The UE of claim 2, wherein the one or more processors are further configured to cause the UE to:
refrain from monitoring the one LO based on a time gap between the LO and the PO being less than the at least one wake-up delay; and
monitor the PO without receiving the LP-WUS.

6. The UE of claim 1, wherein:
the LP-WUS configuration information comprises an indication of at least two LOs and one PO with different time gaps between each of the at least two LOs and the one PO, and
the one or more processors are further configured to cause the UE to:
determine which of the at least two LOs to monitor based on the at least one wake-up delay.

7. The UE of claim 1, wherein:
the LP-WUS configuration information comprises an indication of one LO and at least two POs with different time gaps between the one LO and each of the at least two POs.

8. The UE of claim 1, wherein:
the LP-WUS configuration further comprises an indication of one LO, a first PO, and a second PO,
the LP-WUS configuration information is configured for a UE group or UE subgroup, and
the one or more processors are further configured to cause the UE to:
receive, during the LO, a LP-WUS;
refrain from monitoring the first PO based on a first time gap between the LO and the first PO being shorter than the one or more wake-up delays supported by the UE; and
monitor the second PO based on a second time gap between the LO and the second PO being longer than the one or more wake-up delays supported by the UE.

9. The UE of claim 1, wherein:
a largest time gap between the one or more LOs and the one or more POs is less than a largest wake-up delay supported by the UE, and
the one or more processors are further configured to cause the UE to:
refrain from monitoring the one or more LOs; and
monitor at least one PO of the one or more POs without receiving a LP-WUS.

10. The UE of claim 1, wherein:
a largest time gap between the one or more LOs and the one or more POs is less than a largest wake-up delay supported by the UE, and
the one or more processors are further configured to cause the UE to:
monitor at least one LO of the of the one or more LOs; and
receive, during the at least one LO, a LP-WUS;
refrain from monitoring a first PO, of the one or more POs, based on a first time gap between the LP-WUS and the first PO being shorter than the one or more wake-up delays supported by the UE; and
monitor a second PO, of the one or more POs, based on a second time gap between the LP-WUS and the second PO being longer than the one or more wake-up delays supported by the UE.

11. The UE of claim 9, wherein the at least one LO is a predefined LO associated with a largest time gap, a smallest time gap, or is determined based on an ID of the UE.

12. The UE of claim 1, wherein the one or more processors are further configured to cause the UE to:
receive a LP-WUS during a LO of the one or more LOs; and
monitor a first PO, of the one or more POs, occurring after the at least one wake-up delay, the LO being determined by the UE independent of the first PO.

13. The UE of claim 1, wherein different wake-up delays, of the one or more wake-up delays indicated by the wake-up delay capability information, correspond to different power saving modes of the UE.

14. A base station, comprising:
a memory; and
one or more processors configured to, when executing instructions stored in the memory, cause the base station to:
receive wake-up delay capability information from one or more user equipment (UEs), the wake-up delay capability information comprising one or more wake-up delays supported by each UE of the one or more UEs;
determine, based on the wake-up delay capability information, UE groups of the one or more UEs and a low-power wake-up signal (LP-WUS) configuration for each UE group; and
transmit the LP-WUS configuration for each UE group to the one or more UEs of each UE group,
wherein the LP-WUS configuration for each UE group comprises one or more LP-WUS occasions (LOs) that are separated from one or more paging occasions (POs) by one or more time gaps.

15. The base station of claim 14, wherein the one or more processors are further configured to cause the base station to:
transmit a LP-WUS during an LO of the one or more LOs to the one or more UEs of each UE group of the UE groups based on the LP-WUS configuration for each UE group.

16. The base station of claim 14, wherein the one or more processors are further configured to cause the base station to:
refrain from transmitting a LP-WUS based on a time gap of the one or more time gaps between a LO of thee one or more LOs and a PO of the one or more POs being shorter than the one or more wake-up delays supported by each UE of the one or more UEs; and
transmit a paging message based on refraining from transmitting the LP-WUS.

17. The base station of claim 14, wherein the LP-WUS configuration for each UE group comprises a first LP-WUS configuration for a first UE group of the UE groups and a second LP-WUS configuration for a second UE group of the UE groups, the one or more processors are further configured to cause the base station to:
transmit the first LP-WUS configuration to the first UE group, the first LP-WUS configuration comprising an indication of a first LO and a first PO;
transmit the second LP-WUS configuration to the second UE group, the second LP-WUS configuration comprising an indication of a second LO and a second PO;
transmit a first LP-WUS during the first LO indicating for the first UE group to wake up and monitor the first PO; and
transmit a second LP-WUS during the second LO indicating for the second UE group to wake up and monitor the second PO.

18. The base station of claim 14, wherein the LP-WUS configuration for each UE group comprises a first LP-WUS configuration for a first UE group of the UE groups and a second IP-WUS configuration for a second UE group of the UE groups, the one or more processors are further configured to cause the base station to:
transmit the first LP-WUS configuration to the first UE group, the first LP-WUS configuration comprising an indication of a first LO and a first PO;
transmit the second LP-WUS configuration to the second UE group, the second LP-WUS configuration comprising an indication of a second LO and the first PO;
transmit a first LP-WUS during the first LO indicating for the first UE group to wake up and monitor the first PO; and
transmit a second LP-WUS during the second LO indicating for the second UE group to wake up and monitor the first PO.

19. The base station of claim 14, wherein the one or more processors are further configured to cause the base station to:
transmit, to a UE group of the UE groups, the LP-WUS configuration further comprising an indication of multiple LOs and a PO; and
transmit, to the UE group, multiple LP-WUSs according to the multiple LOs and the PO.

20. Baseband circuitry, comprising:
a memory; and
one or more processors configured to, when executing instructions stored in the memory, cause the baseband circuitry to:
generate wake-up delay capability information indicating one or more wake-up delays;
store low-power wake-up signal (LP-WUS) configuration information indicating one or more LP-WUS occasions (LOs) separated from one or more paging occasions (POs) by one or more time gaps;
identify at least one time gap of the LP-WUS configuration information that is greater than or equal to at least one wake-up delay of the one or more wake-up delays; and
monitor a LO associated with the at least one time gap.
